(19) United States
(12) Patent Application Publication
(10) Pub. No.: US 2023/0198342 A1
(43) Pub. Date: Jun. 22, 2023

(54) ELECTRIC WORK MACHINE

(71) Applicant: MAKITA CORPORATION, Anjo-shi (JP)

(72) Inventor: Yusuke ICHIOKA, Anjo-shi (JP)

(73) Assignee: MAKITA CORPORATION, Anjo-shi (JP)

(21) Appl. No.: 17/975,056

(22) Filed: Oct. 27, 2022

(30) Foreign Application Priority Data
Dec. 17, 2021 (JP) 2021-204821

(51) Int. Cl. H02K 11/20; H02K 5/04; H02K 1/16

(52) U.S. Cl. CPC H02K 11/20; H02K 1/16; H02K 5/04; B27B 17/08

(57) ABSTRACT

An electric work machine includes a resin-molded portion that is designed appropriately. An electric work machine includes a brushless motor, a sensor board, a resin-molded portion, and an output unit. The brushless motor includes a stator and a rotor rotatable relative to the stator. The sensor board faces the rotor and the stator in an axial direction along a rotation axis of the rotor and includes a sensor on an opposing surface of the sensor board opposing the rotor and the stator. The sensor detects a position of the rotor in a rotation direction. The resin-molded portion covers the opposing surface of the sensor board and has a recess at a position corresponding to the stator. The output unit is directly or indirectly drivable by the rotor.

### CROSS-REFERENCE TO RELATED APPLICATIONS

This application claims the benefit of priority to Japanese Patent Application No. 2021-204821, filed on Dec. 17, 2021, the entire contents of which are hereby incorporated by reference.

### BACKGROUND

### 1. Technical Field

The present disclosure relates to an electric work machine.

### 2. Description of the Background

A known air compressor in the field of electric work machines includes a motor, as described in Japanese Unexamined Patent Application Publication No. 2017-038462.

### BRIEF SUMMARY

The motor includes a stator with coils, a rotor with magnets, a sensor board with a sensor that detects the position of the rotor in the rotation direction, and a resin-molded portion covering the sensor board. The resin-molded portion is to be designed for various purposes such as appropriate protection of the sensor board and effective use of the space of the motor.

One or more aspects of the present invention are directed to an electric work machine including a resin-molded portion that is designed appropriately.

A first aspect of the present disclosure provides an electric work machine, including:
a brushless motor including a stator and a rotor rotatable relative to the stator;
a sensor board facing the rotor and the stator in an axial direction along a rotation axis of the rotor, the sensor board including a sensor on an opposing surface of the sensor board, the opposing surface opposing the rotor and the stator, the sensor being configured to detect a position of the rotor in a rotation direction;
a resin-molded portion covering the opposing surface of the sensor board and having a recess at a position corresponding to the stator; and
an output unit directly or indirectly drivable by the rotor.

A second aspect of the present disclosure provides an electric work machine, including:
a brushless motor including a stator and a rotor rotatable relative to the stator;
a sensor board facing the rotor in an axial direction along a rotation axis of the rotor, the sensor board including
   a sensor on an opposing surface of the sensor board, the opposing surface opposing the rotor, the sensor being configured to detect a position of the rotor in a rotation direction, and
   a recess-protrusion portion in a portion of a side surface adjacent to the opposing surface;
a resin-molded portion covering the opposing surface of the sensor board and extending to a position on the opposing surface corresponding to the recess-protrusion portion; and
an output unit directly or indirectly drivable by the rotor.

A third aspect of the present disclosure provides an electric work machine, including:
a brushless motor including a stator and a rotor rotatable relative to the stator;
a sensor board facing the rotor in an axial direction along a rotation axis of the rotor, the sensor board including
   a sensor on an opposing surface of the sensor board, the opposing surface opposing the rotor, the sensor being configured to detect a position of the rotor in a rotation direction,
   a substrate having the opposing surface receiving the sensor and wiring connected to the sensor, and
   a resist layer covering an area with the wiring on the opposing surface;
a resin-molded portion covering the opposing surface of the sensor board; and
an output unit directly or indirectly drivable by the rotor,
wherein the substrate includes a resist-free area without the resist layer in at least a portion of the opposing surface, and
the resin-molded portion is in direct contact with the opposing surface in the resist-free area.

The electric work machine according to the above aspects of the present disclosure includes the resin-molded portion that protects the sensor board appropriately.

### BRIEF DESCRIPTION OF DRAWINGS

FIG. 1 is a perspective view of an electric work machine according to a first embodiment.

FIG. 2 is an exploded perspective view of a motor in the first embodiment as viewed from the rear.

FIG. 3 is an exploded perspective view of the motor in the first embodiment as viewed from the front.

FIG. 4 is an exploded perspective view of a stator and a rotor in the first embodiment as viewed from the rear.

FIG. 5 is an exploded perspective view of the stator and the rotor in the first embodiment as viewed from the front.

FIG. 6 is a perspective view of a sensor board in the first embodiment.

FIG. 7 is a partial perspective view of the sensor board in the first embodiment.

FIG. 8 is a front view of the sensor board in the first embodiment.

FIG. 9 is a partial front view of the sensor board in the first embodiment.

FIG. 10 is a perspective view of the sensor board in the first embodiment.

FIG. 11 is a rear view of the sensor board in the first embodiment.

FIG. 12 is a partial sectional view of the sensor board in the first embodiment.

FIG. 13 is a side view of the sensor board in the first embodiment.

FIG. 14 is a partial sectional view of the sensor board in the first embodiment.

FIG. 15 is a side view of the sensor board and coils in the first embodiment, describing their positional relationship.

FIG. 16 is a sectional view of the sensor board and the coils in the first embodiment, describing their positional relationship.

FIG. 17 is a diagram of the sensor board and the coils in the first embodiment, describing their positional relationship.

FIG. 18 is a diagram of an electric work machine according to a second embodiment.

FIG. 19 is a perspective view of a motor in the second embodiment as viewed from below.

FIG. 20 is an exploded perspective view of the motor in the second embodiment as viewed from below.

FIG. 21 is a perspective view of the motor in the second embodiment as viewed from above.

FIG. 22 is an exploded perspective view of the motor in the second embodiment as viewed from above.

FIG. 23 is a perspective view of a sensor board in the second embodiment as viewed from below.

FIG. 24 is a partial perspective view of the sensor board in the second embodiment as viewed from below.

FIG. 25 is a perspective view of the sensor board in the second embodiment as viewed from above.

FIG. 26 is a partial perspective view of the sensor board in the second embodiment as viewed from above.

FIG. 27 is a plan view of the sensor board in the second embodiment as viewed from below.

FIG. 28 is a partial plan view of the sensor board in the second embodiment as viewed from below.

FIG. 29 is a plan view of the sensor board in the second embodiment as viewed from above.

FIG. 30 is a partial plan view of the sensor board in the second embodiment as viewed from above.

### DETAILED DESCRIPTION

Although one or more embodiments of the present disclosure will now be described with reference to the drawings, the present disclosure is not limited to the embodiments. The components in the embodiments described below may be combined as appropriate. One or more components may be eliminated.

In the embodiments, the positional relationships between the components will be described using the directional terms such as right and left (or lateral), front and rear (or frontward and rearward), and up and down (or vertical). The terms indicate relative positions or directions with respect to the center of an electric work machine.

The electric work machine includes a motor. In the embodiments, a direction parallel to a rotation axis AX of the motor is referred to as an axial direction for convenience. A direction radial from the rotation axis AX of the motor is referred to as a radial direction or radially for convenience. A direction about the rotation axis AX of the motor is referred to as a circumferential direction, circumferentially, or a rotation direction for convenience. A direction parallel to a tangent of an imaginary circle about the rotation axis AX of the motor is referred to as a tangential direction for convenience.

A position nearer the rotation axis AX of the motor in the radial direction, or a radial direction toward the rotation axis AX, is referred to as radially inward for convenience. A position farther from the rotation axis AX of the motor in the radial direction, or a radial direction away from the rotation axis AX, is referred to as radially outside or radially outward for convenience. A position in one circumferential direction, or one circumferential direction, is referred to as a first circumferential direction for convenience. A position in the other circumferential direction, or the other circumferential direction, is referred to as a second circumferential direction for convenience. A position in one tangential direction, or one tangential direction, is referred to as a first tangential direction for convenience. A position in the other tangential direction, or the other tangential direction, is referred to as a second tangential direction for convenience.

### First Embodiment

A first embodiment will now be described.

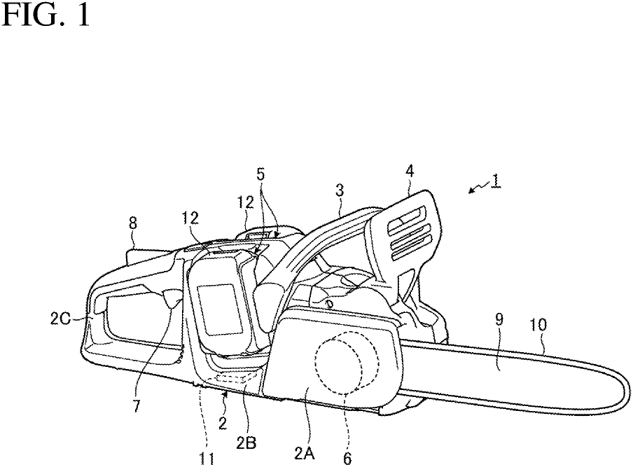

FIG. 1 is a perspective view of an electric work machine 1 according to the present embodiment. The electric work machine 1 according to the present embodiment is a chain saw as an example of outdoor power equipment.

The electric work machine 1 includes a housing 2, a front grip 3, a hand guard 4, battery mounts 5, a motor 6, a trigger switch 7, a trigger lock lever 8, a guide bar 9, a saw chain 10, and a controller 11.

The housing 2 is formed from a synthetic resin. The housing 2 includes a motor compartment 2A, a battery holder 2B, and a rear grip 2C.

The motor compartment 2A accommodates the motor 6. The battery holder 2B is connected to the rear of the motor compartment 2A. The battery mounts 5 are located in the battery holder 2B. The battery holder 2B accommodates the controller 11. The rear grip 2C is connected to the rear of the battery holder 2B.

The front grip 3 is formed from a synthetic resin. The front grip 3 is a pipe. The front grip 3 connects to the battery holder 2B. The front grip 3 has one end and the other end both connected to a surface of the battery holder 2B. An operator uses the electric work machine 1 to perform an operation while holding the front grip 3 and the rear grip 2C with the hands.

The hand guard 4 is located in front of the front grip 3. The hand guard 4 is fixed to the motor compartment 2A. The hand guard 4 protects the hand of the operator holding the front grip 3.

The battery mounts 5 receive battery packs 12. The battery packs 12 are attachable to and detachable from the battery mounts 5. Each battery pack 12 includes a secondary battery. Each battery pack 12 in the present embodiment includes a rechargeable lithium-ion battery. The battery packs 12 are attached to the battery mounts 5 to power the electric work machine 1. The motor 6 is driven by power supplied from the battery packs 12. The controller 11 operates on power supplied from the battery packs 12.

The motor 6 is a power source for the electric work machine 1. The motor 6 generates a rotational force for rotating the saw chain 10. The motor 6 is a brushless motor.

The trigger switch 7 is operable by the operator to drive the motor 6. The trigger switch 7 is located on the rear grip 2C. The trigger switch 7 is moved upward to activate the motor 6. When the trigger switch 7 stops being operated, the motor 6 is stopped.

The trigger lock lever 8 is located on the rear grip 2C. The trigger lock lever 8 allows an operation of the trigger switch 7.

The guide bar 9 is supported by the housing 2. The guide bar 9 is a plate. The saw chain 10 includes multiple cutters that are connected to one another. The saw chain 10 is located along the peripheral edge of the guide bar 9. In response to an operation on the trigger switch 7, the motor 6 is driven. The motor 6 and the saw chain 10 are connected with a power transmission (not shown) including a sprocket. The motor 6 is driven, and the saw chain 10 moves around the peripheral edge of the guide bar 9.

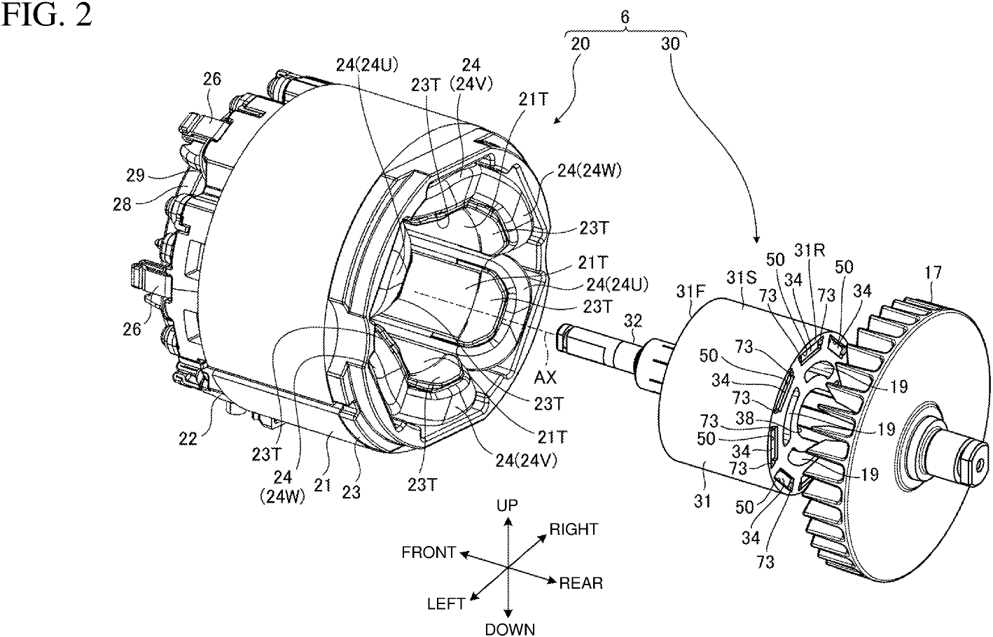

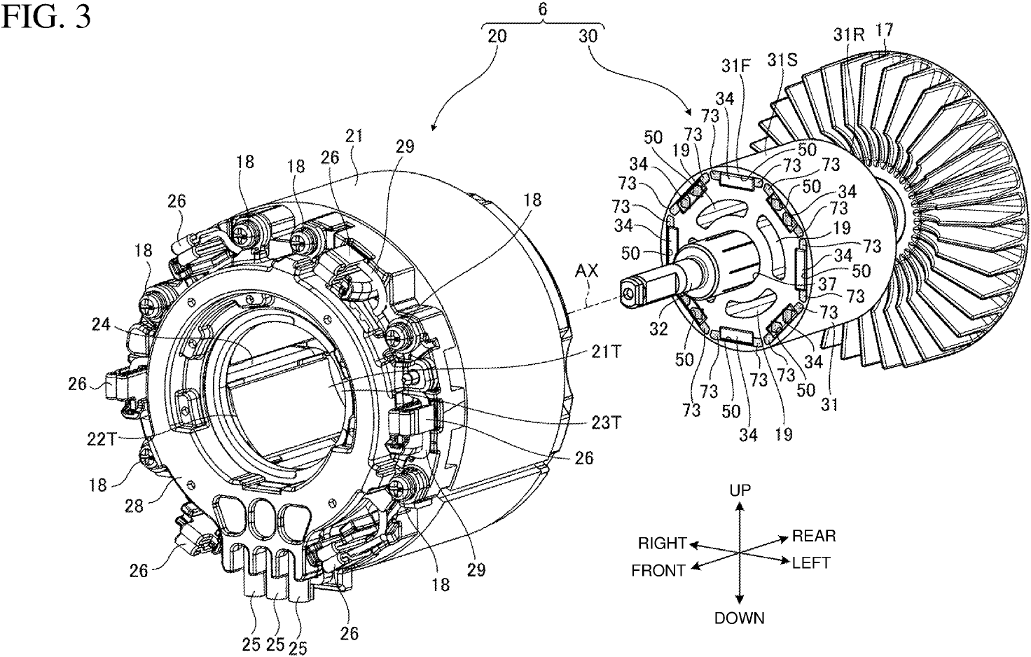

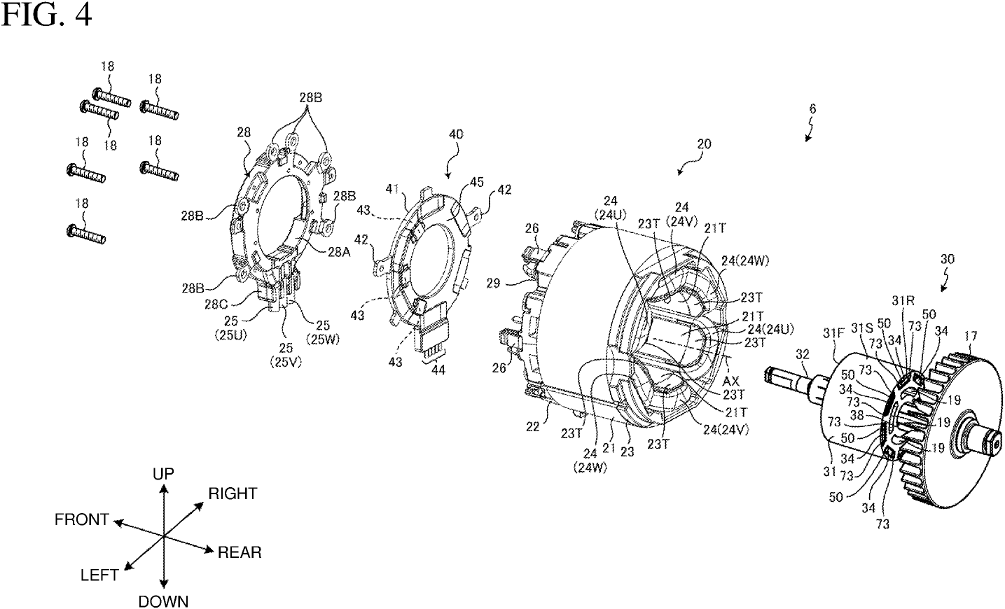

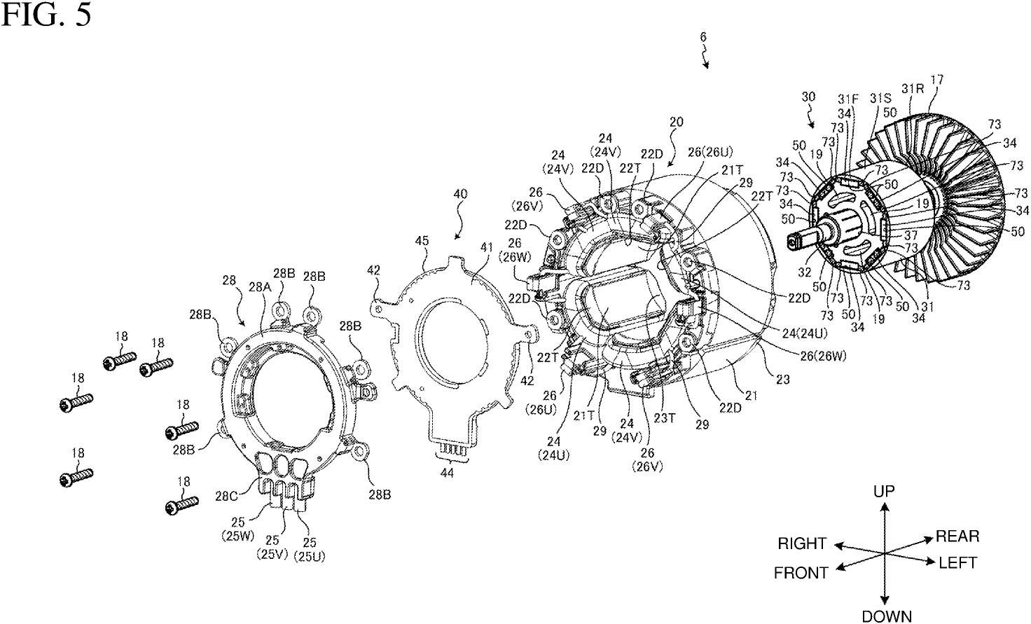

FIG. 2 is an exploded perspective view of the motor 6 in the present embodiment as viewed from the rear. FIG. 3 is an exploded perspective view of the motor 6 in the present embodiment as viewed from the front. FIG. 4 is an exploded perspective view of a stator 20 and a rotor 30 in the present embodiment as viewed from the rear. FIG. 5 is an exploded perspective view of the stator 20 and the rotor 30 in the present embodiment as viewed from the front.

The motor 6 in the present embodiment is an inner-rotor brushless motor. As shown in FIGS. 2 to 5, the motor 6 includes the stator 20 and the rotor 30 rotatable relative to the stator 20. The stator 20 surrounds the rotor 30. The rotor 30 rotates about the rotation axis AX.

The stator 20 includes a stator core 21, a front insulator 22, a rear insulator 23, coils 24, power lines 25, fusing terminals 26, short-circuiting members 27, and an insulating member 28. The front insulator 22 and the rear insulator 23 may be integrally molded with and fixed to the stator core 21.

The stator core 21 includes multiple steel plates stacked on one another. The steel plates are metal plates formed from iron as a main component. The stator core 21 is cylindrical. The stator core 21 includes multiple (six in the present embodiment) teeth 21T to support the coils 24. The teeth 21T protrude radially inward from the inner surface of the stator core 21.

The front insulator 22 is an electrical insulating member formed from a synthetic resin. The front insulator 22 is fixed to the front of the stator core 21. The front insulator 22 is cylindrical. The front insulator 22 includes multiple (six in the present embodiment) protrusions 22T to support the coils 24. The protrusions 22T protrude radially inward from the inner surface of the front insulator 22.

The rear insulator 23 is an electrical insulating member formed from a synthetic resin. The rear insulator 23 is fixed to the rear of the stator core 21. The rear insulator 23 is cylindrical. The rear insulator 23 includes multiple (six in the present embodiment) protrusions 23T to support the coils 24. The protrusions 23T protrude radially inward from the inner surface of the rear insulator 23.

Each tooth 21T has a front end connecting to the rear end of the corresponding protrusion 22T. Each tooth 21T has a rear end connecting to the front end of the corresponding protrusion 23T.

The coils 24 are wound around the teeth 21T on the stator core 21 with the front insulator 22 and the rear insulator 23 in between. The stator 20 includes multiple (six in the present embodiment) coils 24. Each coil 24 is wound around the corresponding tooth 21T with the protrusion 22T and the protrusion 23T in between. Each coil 24 surrounds the tooth 21T, the protrusion 22T, and the protrusion 23T. The coils 24 and the stator core 21 are insulated from each other with the front insulator 22 and the rear insulator 23 in between.

The multiple coils 24 are formed by winding a single wire. The circumferentially adjacent coils 24 are connected with a connection wire 29, which is a part of the wire. Each connection wire 29 is a part of the wire between two adjacent coils 24. The connection wires 29 are supported on the front insulator 22.

The power lines 25 are connected to the battery packs 12 with the controller 11. The battery packs 12 serve as a power supply for the motor 6. The battery packs 12 supply a drive current to the motor 6 through the controller 11. The controller 11 controls the drive current supplied from the battery packs 12 to the motor 6. The drive current from the battery packs 12 is supplied to the power lines 25 through the controller 11.

The fusing terminals 26 are connected to the coils 24 through the connection wires 29. The fusing terminals 26 conduct electricity. Multiple (six in the present embodiment) fusing terminals 26 surround the rotation axis AX. The fusing terminals 26 are as many as the coils 24. The fusing terminals 26 are supported on the front insulator 22.

Each connection wire 29 is located inside a bent portion of the fusing terminal 26. The fusing terminals 26 and the connection wires 29 are welded together. The fusing terminals 26 are thus connected to the connection wires 29.

The short-circuiting members 27 connect the fusing terminals 26 and the power line 25. The short-circuiting members 27 conduct electricity. The short-circuiting members 27 are curved in a plane orthogonal to the rotation axis AX. The stator 20 includes multiple (three in the present embodiment) short-circuiting members 27. Each short-circuiting member 27 connects (short-circuits) the single power line 25 and the pair of fusing terminals 26. Each short-circuiting member 27 has an opening 27A receiving a front portion of the fusing terminal 26. Each fusing terminal 26 has the front portion received in the opening 27A and thus is connected to the short-circuiting member 27.

The insulating member 28 supports the power lines 25 and the short-circuiting members 27. The insulating member 28 is formed from a synthetic resin. The insulating member 28 includes a body 28A, a screw boss 28B, and a support 28C.

The body 28A is annular. In the embodiment, the short-circuiting members 27 are at least partially located in the body 28A. The short-circuiting members 27 are fixed to the body 28A by insert molding. The fusing terminals 26 are supported on the body 28A with the short-circuiting members 27 in between. The body 28A insulates the three short-circuiting members 27 from one another.

The screw bosses 28B protrude radially outward from the peripheral edge of the body 28A. Six screw bosses 28B are arranged on the peripheral edge of the body 28A.

The support 28C protrudes downward from a lower portion of the body 28A. The support 28C supports the power lines 25.

The power lines 25, the fusing terminals 26, the short-circuiting members 27, and the insulating member 28 are located frontward from the stator core 21. The fusing terminals 26 are located at least partially rearward from the short-circuiting members 27 and the insulating member 28.

The rotor 30 includes a rotor core 31, a rotor shaft 32, and magnetic pole units 34. The rotor 30 rotates about the rotation axis AX.

The rotor core 31 includes multiple steel plates stacked on one another. The steel plates are metal plates formed from iron as a main component. The rotor core 31 surrounds the rotation axis AX.

The rotor core 31 is substantially cylindrical. The rotor core 31 has a shaft opening 37 in its center. The shaft opening 37 extends through the front and rear surfaces of the rotor core 31. The rotor core 31 has a front end 31F and a rear end 31R.

The rotor shaft 32 extends in the axial direction. The rotor shaft 32 is located inward from the rotor core 31. The rotor shaft 32 is received in the shaft opening 37. The rotor shaft 32 is fixed to the rotor core 31. The rotor shaft 32 has a front portion protruding frontward from the front end 31F of the rotor core 31. The rotor shaft 32 has a rear portion protruding rearward from the rear end 31R of the rotor core 31. The rotor shaft 32 has the front portion rotatably supported by a front bearing (not shown). The rotor shaft 32 has the rear portion rotatably supported by a rear bearing (not shown).

The saw chain 10 functions as an output unit of the electric work machine 1 directly driven by the rotor 30. The sprocket is directly fixed to the rotor shaft 32. In other words, the motor 6 in the present embodiment drives the saw chain 10 with a direct drive system. A reducer is not located between the motor 6 and the sprocket. A reducer may be located between the motor 6 and the sprocket. Thus, the saw chain 10 functioning as the output unit of the electric work machine 1 may be indirectly driven by the rotor 30. The reducer allows the saw chain 10 to drive with higher torque.

Multiple (eight in the present embodiment) magnetic pole units 34 are located in the circumferential direction of the rotor core 31. The circumferential direction of the rotor core 31 is the circumferential direction of the rotation axis AX. The magnetic pole units 34 include permanent magnets 33 fixed to the rotor core 31.

The magnetic pole units 34 include first magnetic pole units 34N and second magnetic pole units 34S with different poles. The first magnetic pole units 34N and the second magnetic pole units 34S are located alternately in the circumferential direction of the rotor core 31. Four first magnetic pole units 34N surround the rotation axis AX at intervals. Four second magnetic pole units 34S surround the rotation axis AX at intervals. The permanent magnets 33 included in the first magnetic pole units 34N each are fixed to the rotor core 31 to have an N pole facing radially outward and an S pole facing radially inward. The permanent magnets 33 included in the second magnetic pole units 34S each are fixed to the rotor core 31 to have an S pole facing radially outward and an N pole facing radially inward.

The permanent magnets 33 in the present embodiment are located inside the rotor core 31. The motor 6 is an interior permanent magnet (IPM) motor.

The permanent magnets 33 are neodymium-iron-boron (NdFeb) sintered magnets. Each permanent magnet 33 has remanence of 1.0 to 1.5 T inclusive.

A fan 17 is fixed to the rear portion of the rotor shaft 32. The fan 17 is located rearward from the rotor core 31. The fan 17 at least partially faces the rear end 31R of the rotor core 31. As the rotor shaft 32 rotates, the fan 17 rotates together with the rotor shaft 32.

The rotor core 31 has multiple (eight in the present embodiment) magnet slots 50 located circumferentially at intervals. The permanent magnets 33 are received in the respective magnet slots 50. Multiple magnet slots 50 are located circumferentially at equal intervals. The magnet slots 50 have the same shape in a plane perpendicular to the rotation axis AX. The magnet slots 50 have the same dimensions in a plane perpendicular to the rotation axis AX.

A surface of each permanent magnet 33 in the corresponding magnet slot 50 and at least a part of the inner surface of the magnet slot 50 define a space 71 between them. The space 71 receives a resin portion 73.

The rotor core 31 has through-holes 19. The through-holes 19 extend through the front and rear surfaces of the rotor core 31. In the radial direction, the through-holes 19 are located between the shaft opening 37 and the outer surface 31S of the rotor core 31. Four through-holes 19 surround the rotation axis AX. The through-holes 19 are arc-shaped in a plane perpendicular to the rotation axis AX. The through-holes 19 reduce the weight of the rotor core 31.

The number of poles indicating the number of magnetic pole units 34 is greater than the number of slots indicating the number of coils 24. The number of poles indicating the number of magnetic pole units 34 may be six or greater. As described above, the motor 6 in the embodiment includes the eight magnetic pole units 34 and the six coils 24. Thus, the number of poles indicating the number of magnetic pole units 34 is eight. The number of slots indicating the number of coils 24 is six. The number of pole pairs indicating the number of pairs of the first magnetic pole unit 34N and the second magnetic pole unit 34S is four.

The electric work machine 1 includes a sensor board 40 including magnetic sensors 43 for detecting rotation of the rotor 30. The magnetic sensors 43 are, for example, Hall sensors. The sensor board 40 is located frontward from the front insulator 22. The sensor board 40 faces the front insulator 22. The sensor board 40 is located frontward from the rotor core 31.

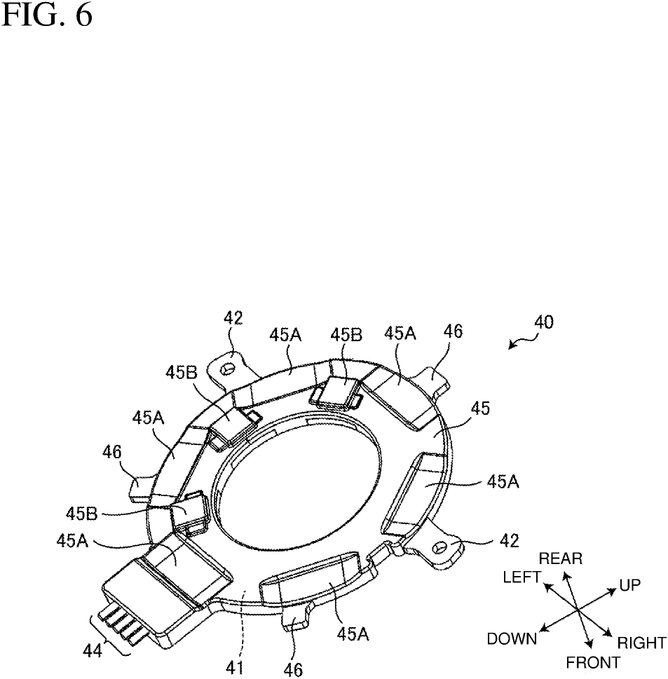

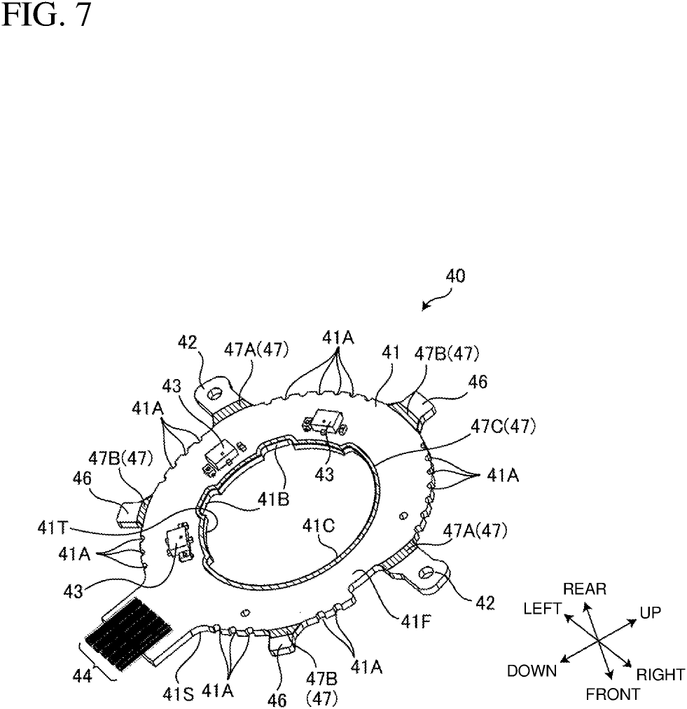

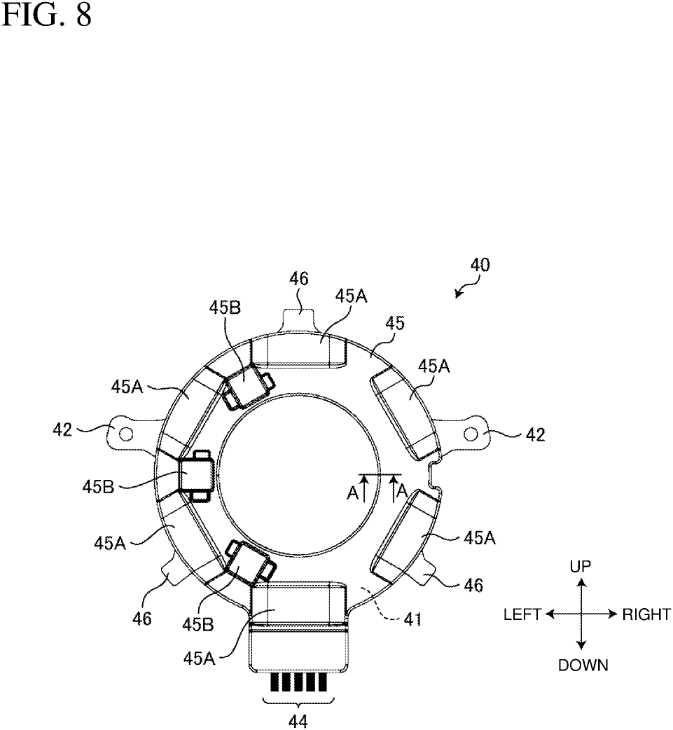

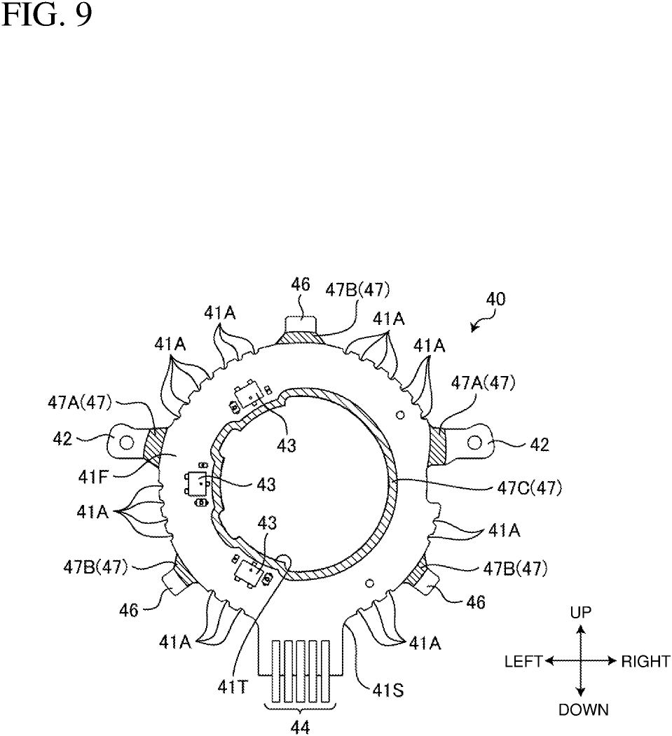

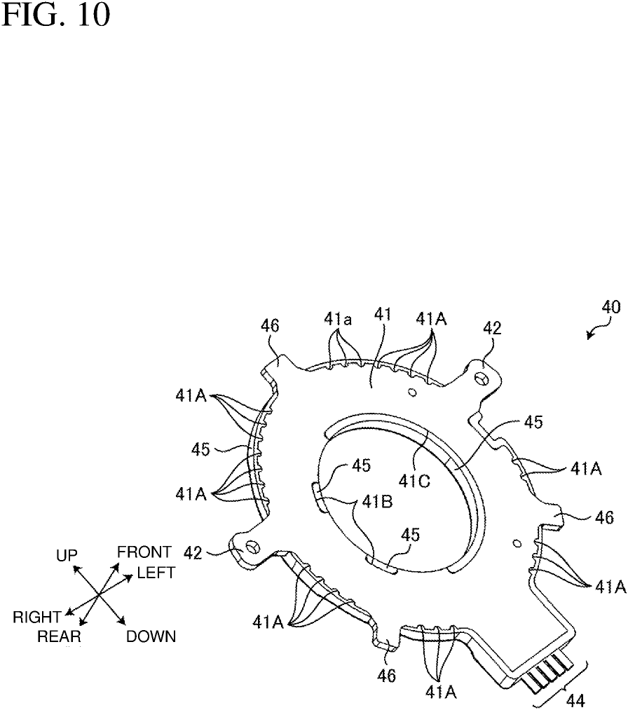

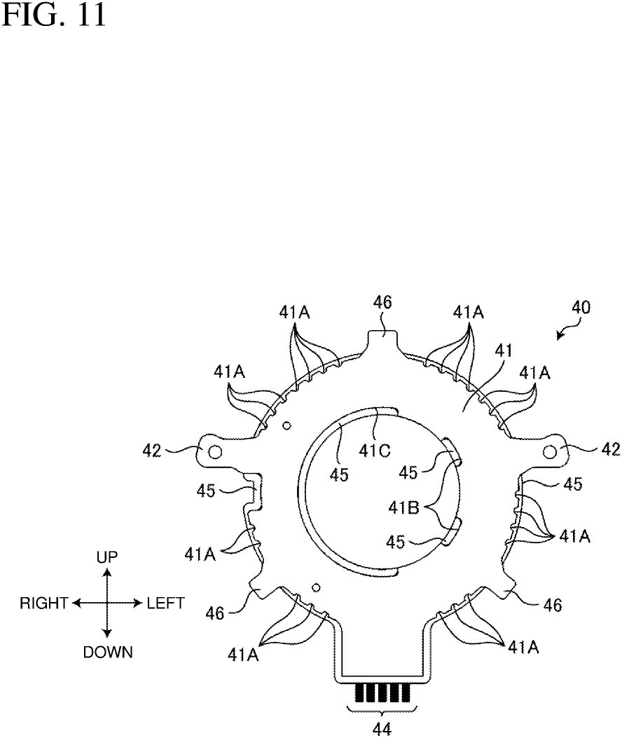

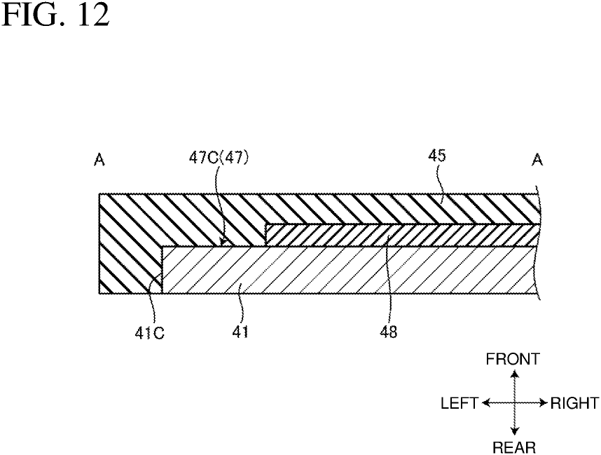

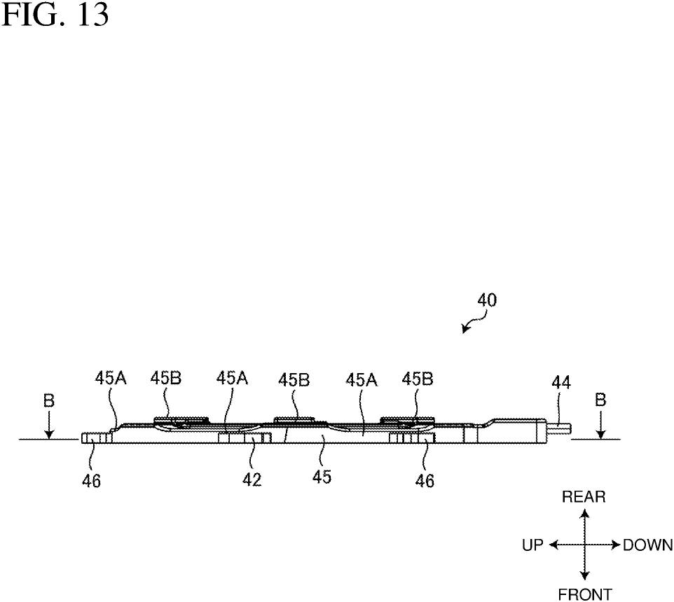

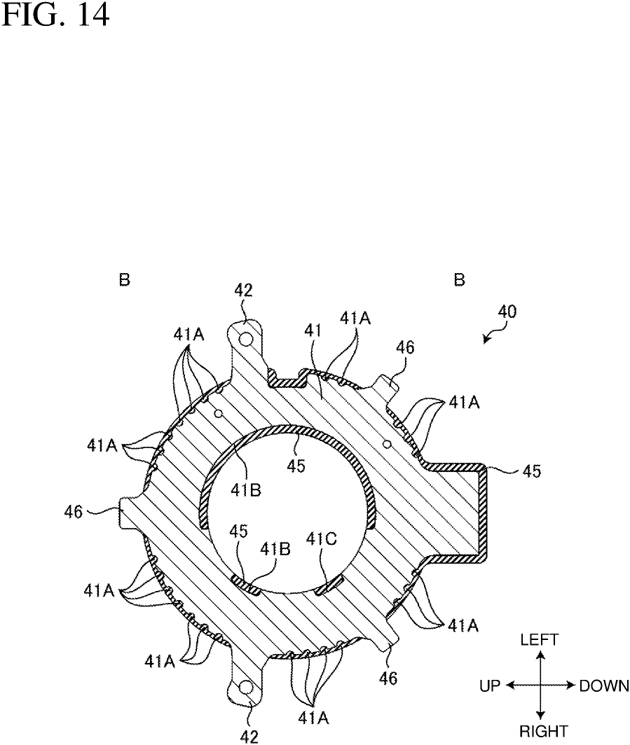

FIG. 6 is a perspective view of the sensor board in the first embodiment. FIG. 7 is a partial perspective view of the sensor board in the first embodiment. FIG. 8 is a front view of the sensor board in the first embodiment. FIG. 9 is a partial front view of the sensor board in the first embodiment. FIG. 10 is a perspective view of the sensor board in the first embodiment. FIG. 11 is a rear view of the sensor board in the first embodiment. FIG. 12 is a partial sectional view of the sensor board in the first embodiment. FIG. 13 is a side view of the sensor board in the first embodiment. FIG. 14 is a partial sectional view of the sensor board in the first embodiment.

As shown in FIGS. 6 to 14, the sensor board 40 includes a plate 41, screw bosses 42, the magnetic sensors 43, signal lines 44, and projections 46.

The plate 41 surrounds the front portion of the rotor shaft 32. The plate 41 is annular. The plate 41 has an opposing surface 41F and side surfaces 41S and 41T adjacent to the opposing surface 41F. The opposing surface 41F opposes the front end 31F of the rotor core 31. The side surface 41S is a radially outer surface, or more specifically, an outer peripheral surface. The side surface 41T is a radially inner surface, or more specifically, an inner peripheral surface.

The plate 41 includes recess-protrusion portions 41A in portions of the side surface 41S. The recess-protrusion portions 41A are cutouts in portions of the side surface 41S. The recess-protrusion portions 41A include multiple recesses and multiple protrusions located alternately in the circumferential direction of the side surface 41S. The recess-protrusion portions 41A are located between the projections 46 and the screw bosses 42 and between the projections 46 and the signal line holder 44A on the side surface 41S.

The plate 41 has recesses 41B and 41C on portions of the side surface 41T.

The screw bosses 42 protrude radially outward from the peripheral edge of the plate 41. Two screw bosses 42 are arranged on the peripheral edge of the plate 41. The projections 46 protrude radially outward from the peripheral edge of the plate 41. Three projections 46 are arranged on the peripheral edge of the plate 41.

The magnetic sensors 43 are located on the opposing surface 41F. The magnetic sensors 43 face the front end 31F of the rotor core 31. In this state, the magnetic sensors 43 detect rotation of the rotor 30. The magnetic sensors 43 detect the magnetic flux of the permanent magnets 33 to detect the position of the rotor 30 in the rotation direction.

The magnetic sensors 43 are supported on the plate 41. The magnetic sensors 43 each include a Hall device. Three magnetic sensors 43 are located at intervals of 60°.

The detection signals from the magnetic sensors 43 are output to the controller 11 through the signal lines 44. The controller 11 provides a drive current to the multiple coils 24 based on the detection signals from the magnetic sensors 43.

The electric work machine 1 includes a resin-molded portion 45 covering the opposing surface 41F. The resin-molded portion 45 includes sensor covers 45B covering the magnetic sensors 43. The sensor covers 45B each have a height from the opposing surface 41F greater than other portions. The opposing surface 41F of the plate 41 receives, for example, electronic components and wiring, in addition to the magnetic sensors 43. The resin-molded portion 45 also covers, for example, these electronic components and wiring. Examples of the electronic components include capacitors, resistors, and thermistors.

The resin-molded portion 45 insulates electricity and transmits a magnetic field. The resin-molded portion 45 protects the sensor board 40, or more specifically, the plate 41, the magnetic sensors 43, the electronic components, and the wiring (not shown). The resin-molded portion 45 is formed by low-temperature, low-pressure injection molding. The plate 41 is placed in a mold, into which a heat-melted synthetic resin is extruded at a low pressure of 0.1 to 10 MPa inclusive to be integrally molded with the plate 41. In one or more embodiments, a synthetic resin forming the resin-molded portion 45 may be a thermoplastic resin with a softening point of less than 200° C. and may be a thermoplastic resin with a melting point of less than 200° C. The synthetic resin forming the resin-molded portion 45 is, for example, a synthetic resin containing, as a main component (at a percentage by weight of 50% or more), polyamide (nylon) containing an aliphatic skeleton.

The resin-molded portion 45 extends across the opposing surface 41F and the side surfaces 41S and 41T. The resin-molded portion 45 covers the recess-protrusion portions 41A of the side surface 41S. The resin-molded portion 45 extends across the recesses 41B and 41C on the side surface 41T. The resin-molded portion 45 covers the recess-protrusion portions 41A and the recesses 41B and 41C, and thus has a larger contact area with the side surfaces 41S and 41T of the plate 41. This increases the bonding strength between the resin-molded portion 45 and the plate 41.

The opposing surface 41F of the plate 41 receives, for example, the wiring connected to the magnetic sensors 43. The opposing surface 41F includes a resist layer 48 (refer to FIG. 12) covering an area with the wiring. The opposing surface 41F includes resist-free areas 47 without the resist layer 48. The opposing surface 41F is exposed in the resist-free areas 47. The resist-free areas 47 include first areas 47A, second areas 47B, and a third area 47C. The first areas 47A include the boundaries between the plate 41 and the screw bosses 42. The second areas 47B include the boundaries between the plate 41 and the projections 46. The third area 47C is a peripheral area extending along the inner periphery of the plate 41. In the resist-free areas 47, the opposing surface 41F is exposed, and thus the resin-molded portion 45 is in direct contact with the opposing surface 41F. The resin-molded portion 45 has a higher bonding strength in the resist-free areas 47 than in an area with the resist layer 48.

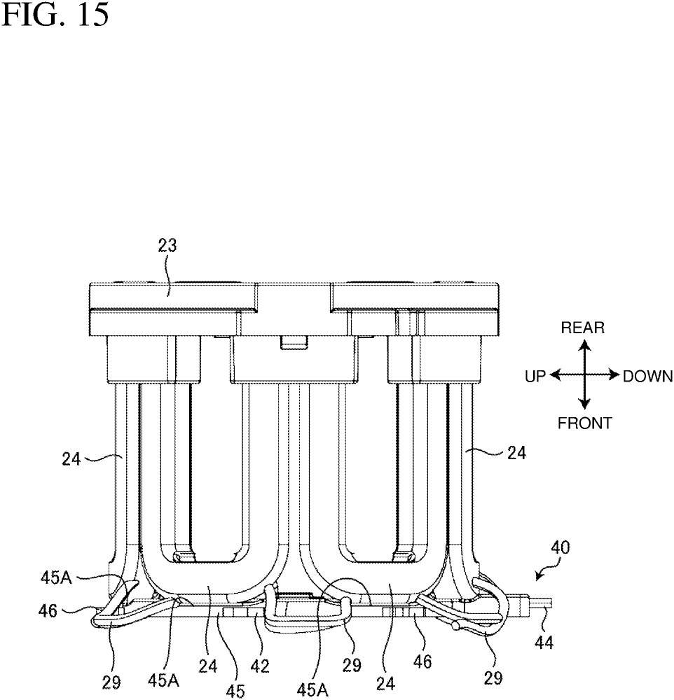

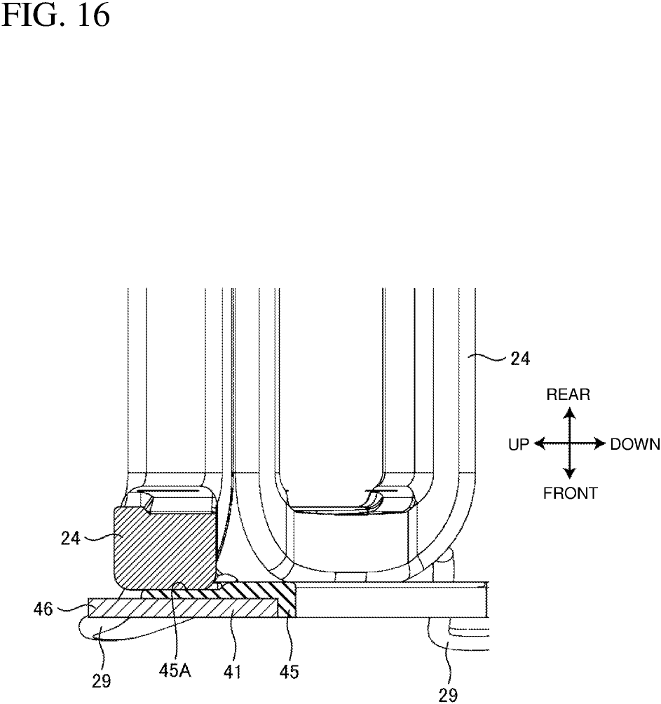

The resin-molded portion 45 has recesses 45A. FIG. 15 is a side view of the sensor board and the coils in the first embodiment, describing their positional relationship. FIG. 16 is a sectional view of the sensor board and the coils in the first embodiment, describing their positional relationship. As shown in FIGS. 15 and 16, the recesses 45A overlap the coils 24 as viewed in the axial direction along the rotation axis AX of the motor 6. The recesses 45A are at positions corresponding to the coils 24 in the resin-molded portion 45. Thus, the coils 24 are closer to the sensor board 40. This reduces the axial dimension of the motor 6 along the rotation axis AX.

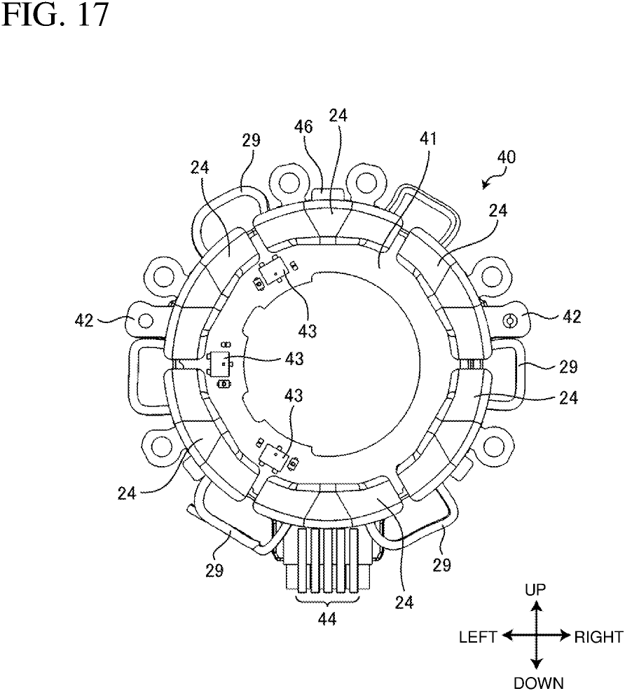

FIG. 17 describes the positional relationship between the sensor board and the coils in the first embodiment. FIG. 17 shows the sensor board 40 as viewed in the axial direction along the rotation axis AX of the motor 6. FIG. 17 does not show components around the coils 24. As shown in FIG. 17, the sensor covers 45B in the resin-molded portion 45 do not overlap the coils 24 as viewed in the axial direction along the rotation axis AX of the motor 6. The coils 24 closer to the sensor board 40 do not interfere with the sensor covers 45B.

The electric work machine 1 according to the present embodiment includes the motor 6, the sensor board 40, the resin-molded portion 45, and the saw chain 10. The motor 6 includes the stator 20 and the rotor 30 rotatable relative to the stator 20. The sensor board 40 faces the rotor 30 and the stator 20 in the axial direction along the rotation axis AX of the rotor 30, and includes, on the opposing surface 41F opposing the rotor 30 and the stator 20, the magnetic sensors 43 that detect the position of the rotor 30 in the rotation direction. The resin-molded portion 45 covers the opposing surface 41F of the sensor board 40. The saw chain 10 is directly or indirectly driven by the rotor 30. The resin-molded portion 45 may have the recesses 45A at the positions corresponding to the stator 20.

This allows the stator 20 to be closer to the sensor board 40. The motor 6 is thus compact in the axial direction along the rotation axis AX. Thus, the electric work machine 1 includes the resin-molded portion 45 designed appropriately for effective use of the space of the motor 6.

The rotor 30 in the embodiment may include the rotor core 31 and the permanent magnets 33 fixed to the rotor core 31. The stator 20 may include the stator core 21, the front insulator 22 fixed to the stator core 21, and the coils 24 attached to the front insulator 22. The recesses 45A may be at the positions corresponding to the coils 24.

This allows the coils 24 to be closer to the sensor board 40. The motor 6 is thus compact in the axial direction along the rotation axis AX.

The recesses 45A in the embodiment may overlap the coils 24 as viewed in the axial direction.

This minimizes an area in which the recesses 45A are located. Thus, the resin-molded portion 45 sufficiently protects the sensor board 40.

The electric work machine 1 according to the embodiment includes the motor 6, the sensor board 40, the resin-molded portion 45, and the saw chain 10. The motor 6 includes the stator 20 and the rotor 30 rotatable relative to the stator 20. The sensor board 40 faces the rotor 30 in the axial direction along the rotation axis AX of the rotor 30, and includes, on the opposing surface 41F opposing the rotor 30, the magnetic sensors 43 that detect the position of the rotor 30 in the rotation direction. The resin-molded portion 45 covers the opposing surface 41F of the sensor board 40. The saw chain 10 is directly or indirectly driven by the rotor 30. The sensor board 40 includes the recess-protrusion portions 41A in portions of the side surfaces 41S and 41T adjacent to the opposing surface 41F. The resin-molded portion 45 may extend to the positions corresponding to the recess-protrusion portions 41A of the opposing surface 41F.

The resin-molded portion 45 thus has a larger contact area with the opposing surface 41F. This increases the bonding strength between the resin-molded portion 45 and the sensor board 40. Thus, the electric work machine 1 includes the resin-molded portion 45 designed appropriately for reliable protection of the sensor board 40.

The resin-molded portion 45 in the embodiment may extend across the opposing surface 41F and the side surfaces 41S and 41T.

Thus, the resin-molded portion 45 protects the opposing surface 41F more reliably.

The sensor board 40 in the embodiment may be annular. The side surfaces 41S and 41T may include the outer side surface 41S and the inner side surface 41T of the sensor board 40.

Thus, the resin-molded portion 45 extends across the opposing surface 41F and the outer side surface 41S and the inner side surface 41T of the sensor board 40, and thus protects the opposing surface 41F more reliably.

The electric work machine 1 according to the embodiment includes the motor 6, the sensor board 40, the resin-molded portion 45, and the saw chain 10. The motor 6 includes the stator 20 and the rotor 30 rotatable relative to the stator 20. The sensor board 40 faces the rotor 30 in the axial direction along the rotation axis AX of the rotor 30, and includes, on the opposing surface 41F opposing the rotor 30, the magnetic sensors 43 that detect the position of the rotor 30 in the rotation direction. The resin-molded portion 45 covers the opposing surface 41F of the sensor board 40. The saw chain 10 is directly or indirectly driven by the rotor 30. The sensor board 40 includes the plate 41 having the opposing surface 41F receiving the magnetic sensors 43 and the wiring connected to the magnetic sensors 43, and the resist layer 48 covering the area with the wiring on the opposing surface 41F. The plate 41 includes the resist-free areas 47 without the resist layer 48 in at least a portion of the opposing surface 41F. The resin-molded portion 45 may be in direct contact with the opposing surface 41F in the resist-free areas 47.

The resin-molded portion 45 has a higher bonding strength in the resist-free areas 47 than in the area with the resist layer 48. Thus, the electric work machine 1 includes the resin-molded portion 45 designed appropriately for reliable protection of the sensor board 40.

The resist-free areas 47 in the present embodiment may include a peripheral portion of the opposing surface 41F.

Thus, the resin-molded portion 45 has a higher bonding strength on the peripheral portion of the opposing surface 41F.

The sensor board 40 in the embodiment may be annular and may have a peripheral portion including the first areas 47A and the second areas 47B, which are outer peripheral portions of the sensor board 40, and the third area 47C, which is an inner peripheral portion of the sensor board 40.

Thus, the resin-molded portion 45 has a higher bonding strength in the first areas 47A and the second areas 47B, which are the outer peripheral portions of the sensor board 40, and the third area 47C, which is the inner peripheral portions of the sensor board 40.

Although the motor 6 is an inner-rotor brushless motor in the first embodiment, the motor 6 may have another structure. The motor 6 may be an outer-rotor brushless motor.

### Second Embodiment

A second embodiment will now be described.

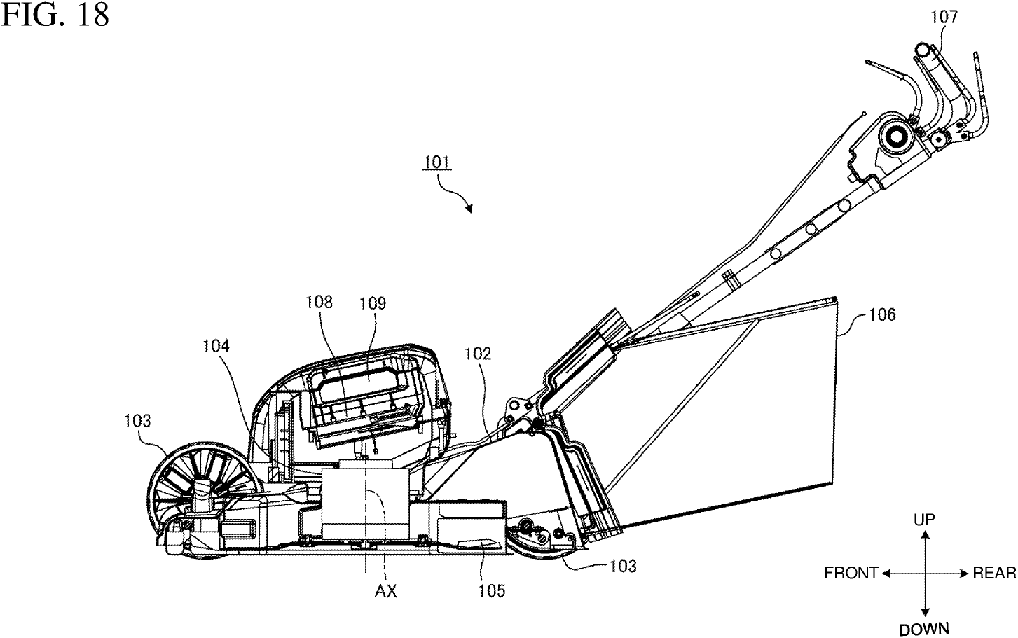

FIG. 18 shows an electric work machine 101 according to the embodiment. The electric work machine 101 according to the present embodiment is a lawn mower, which is an example of outdoor power equipment.

As shown in FIG. 18, the electric work machine 101 includes a housing 102, multiple (four in the present embodiment) wheels 103, a motor 104, a cutting blade 105, a grass box 106, a handle 107, and a battery mount 108.

The housing 102 accommodates the motor 104 and the cutting blade 105. The housing 102 supports the wheels 103, the motor 104, and the cutting blade 105.

The wheels 103 rotate on the ground. The wheels 103 rotate to move the electric work machine 101 on the ground.

The motor 104 is a power source for the electric work machine 101. The motor 104 generates a rotational force for rotating the cutting blade 105. The motor 104 is located above the cutting blade 105.

The cutting blade 105 is connected to the motor 104. The cutting blade 105 is an output unit in the electric work machine 101 that is drivable by the motor 104. The cutting blade 105 is rotatable about the rotation axis AX of the motor 104 under the rotational force generated by the motor 104. The cutting blade 105 faces the ground. With the wheels 103 in contact with the ground, the cutting blade 105 rotates while mowing grass on the ground. The grass mown by the cutting blade 105 is collected in the grass box 106.

A user holds the handle 107 of the electric work machine 101 with the hands. The user holding the handle 107 can move the electric work machine 101.

A battery pack 109 is attached to the battery mount 108 in a detachable manner. The battery pack 109 powers the electric work machine 101. The battery pack 109 includes a secondary battery. The battery pack 109 in the present embodiment includes a rechargeable lithium-ion battery. The battery pack 109 is attached to the battery mount 108 to power the electric work machine 101. The battery pack 109 supplies a drive current to drive the motor 104.

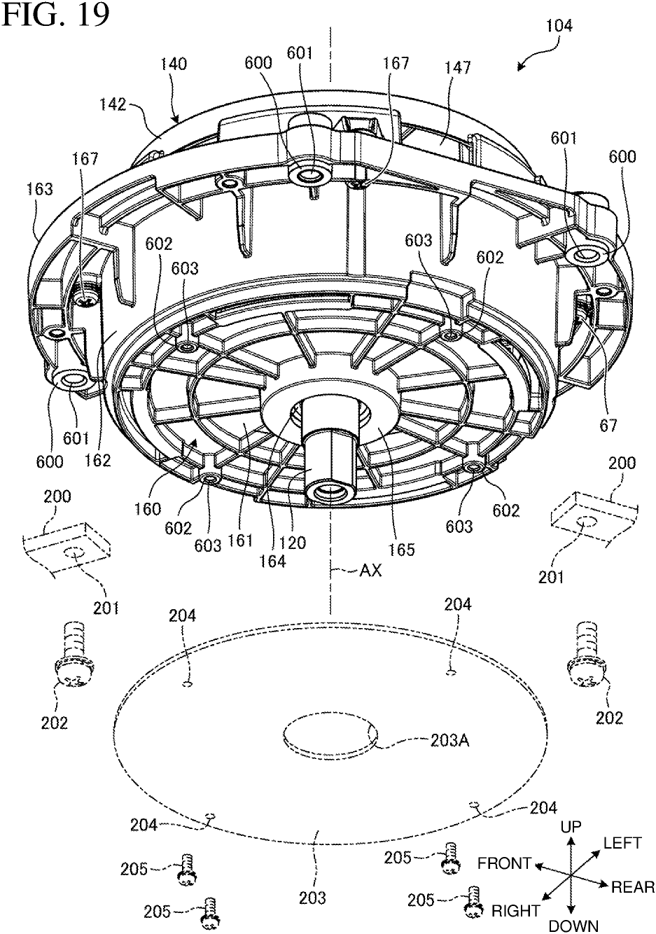

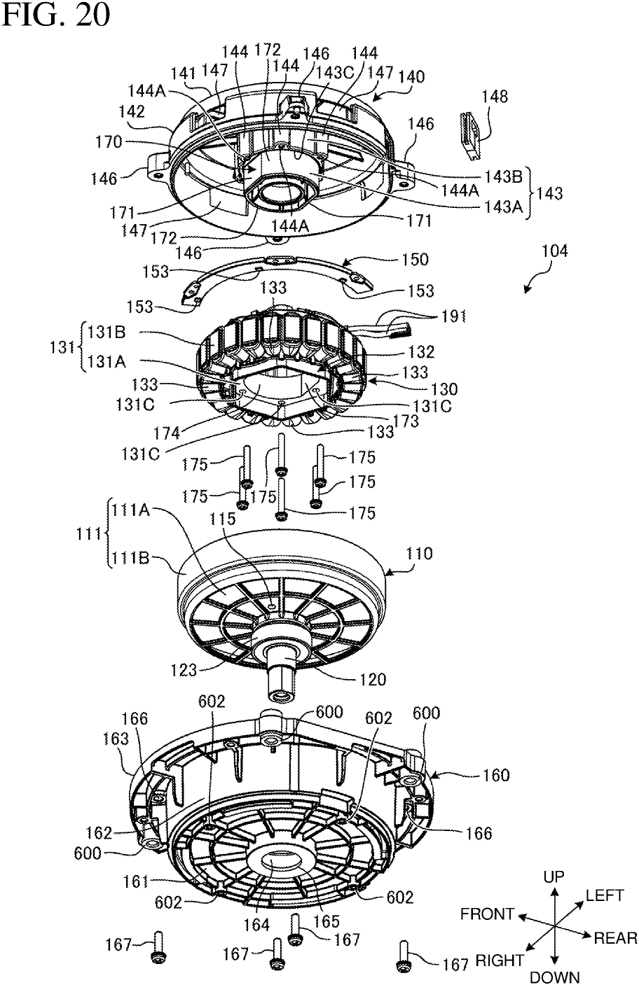

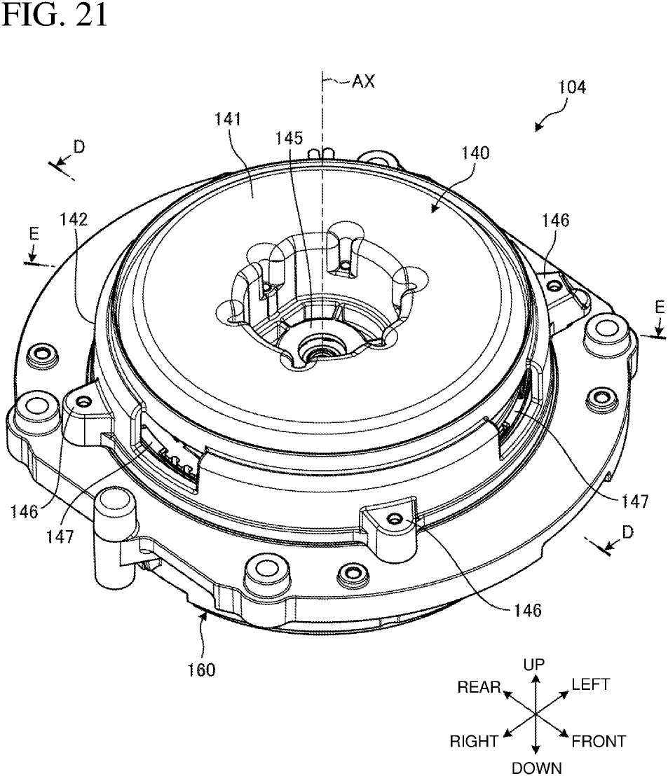

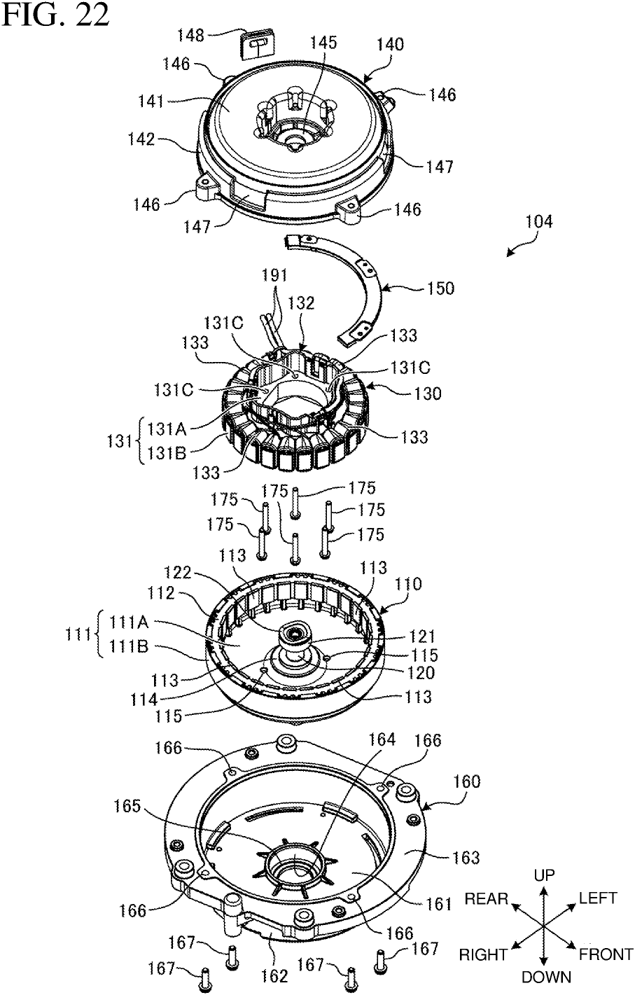

FIG. 19 is a perspective view of the motor 104 in the embodiment as viewed from below. FIG. 20 is an exploded perspective view of the motor 104 in the embodiment as viewed from below. FIG. 21 is a perspective view of the motor 104 in the embodiment as viewed from above. FIG. 22 is an exploded perspective view of the motor 104 in the embodiment as viewed from above. The motor 104 in the embodiment is an outer-rotor brushless motor.

As shown in FIGS. 19 to 22, the motor 104 includes a rotor 110, a rotor shaft 120, a stator 130, a stator base 140, a sensor board 150, and a motor housing 160. The rotor 110 is rotatable relative to the stator 130. The rotor 110 at least partially surrounds the stator 130. The rotor 110 is located adjacent to the outer periphery of the stator 130. The rotor shaft 120 is fixed to the rotor 110. The rotor 110 and the rotor shaft 120 rotate about the rotation axis AX. The stator base 140 supports the stator 130. The cutting blade 105 is connected to the rotor shaft 120. The cutting blade 105 is drivable by the rotor 110. The sensor board 150 supports magnetic sensors for detecting rotation of the rotor 110.

In the embodiment, the motor 104 has a rotation axis AX in the vertical direction. The axial direction and the vertical direction are parallel to each other.

The rotor 110 includes a rotor cup 111, a rotor core 112, and magnets 113.

The rotor cup 111 is formed from an aluminum-based metal. The rotor cup 111 includes a plate 111A and a yoke 111B.

The plate 111A is substantially annular. The plate 111A surrounds the rotation axis AX. The plate 111A has the central axis aligned with the rotation axis AX. The plate 111A has an opening 111C at its center. The rotor shaft 120 is at least partially located in the opening 111C. A bush 114 is located between the outer surface of the rotor shaft 120 and the inner surface of the opening 111C.

The yoke 111B is substantially cylindrical. The yoke 111B has a lower end connected to the periphery of the plate 111A. The plate 111A is integral with the yoke 111B. The yoke 111B extends upward from the periphery of the plate 111A. The yoke 111B surrounds the stator 130. The yoke 111B surrounds the rotation axis AX. The yoke 111B has the central axis aligned with the rotation axis AX.

The rotor core 112 includes multiple steel plates stacked on one another in the axial direction. The rotor core 112 is substantially cylindrical. The rotor core 112 is supported by the rotor cup 111. The rotor cup 111 at least partially surrounds the rotor core 112. The rotor core 112 is located radially inward from the yoke 111B. The rotor core 112 is surrounded by the yoke 111B. The rotor core 112 is supported on the inner circumferential surface of the yoke 111B.

The magnets 113 are permanent magnets. The magnets 113 are sintered plate magnets. The magnets 113 are fixed to the rotor core 112. The magnets 113 are located radially inward from the rotor core 112. The magnets 113 are fixed to the inner circumferential surface of the rotor core 112 with an adhesive. Multiple (28 in the present embodiment) magnets 113 are arranged at circumferentially equal intervals with their N poles and S poles located alternately in the circumferential direction.

The rotor shaft 120 extends in the axial direction. The rotor shaft 120 is fixed to the rotor 110. The rotor 110 includes a lower portion received inside the opening 111C in the plate 111A. The rotor shaft 120 is fastened to the plate 111A with the bush 114. The upper end of the rotor shaft 120 is located above the upper surface of the plate 111A. The lower end of the rotor shaft 120 is located below the lower surface of the plate 111A.

The rotor shaft 120 has the central axis aligned with the rotation axis AX. The rotor shaft 120 is fixed to the rotor 110 with its central axis aligned with the central axis of the yoke 111B.

The stator 130 includes a stator core 131, an insulator 132, and multiple (24 in the present embodiment) coils 133.

The stator core 131 includes multiple steel plates stacked on one another in the axial direction. The stator core 131 includes a yoke 131A and teeth 131B. The yoke 131A is cylindrical. The yoke 131A surrounds the rotation axis AX. The yoke 131A has an outer circumferential surface with the central axis aligned with the rotation axis AX. The teeth 131B protrude radially outward from the outer circumferential surface of the yoke 131A. Multiple (24 in the present embodiment) teeth 131B are located circumferentially at intervals. The teeth 131B adjacent to each other have a slot in between.

The insulator 132 is formed from a synthetic resin. The insulator 132 is fixed to the stator core 131. The insulator 132 covers at least a part of the surface of the stator core 131. The insulator 132 covers at least parts of the end faces of the yoke 131A facing in the axial direction. The end faces of the yoke 131A include an upper end face facing upward and a lower end face facing downward. The insulator 132 covers at least a part of the outer surface of the yoke 131A facing radially outward. The insulator 132 covers at least parts of the surfaces of the teeth 131B.

In the embodiment, the stator core 131 and the insulator 132 are integral with each other. The insulator 132 is fixed to the stator core 131 by insert molding. The stator core 131 accommodated in a die receives injection of a heat-melted synthetic resin. The synthetic resin then solidifies to form the insulator 132 fixed to the stator core 131.

The coils 133 are attached to the insulator 132. Each coil 133 is wound around the corresponding tooth 131B with the insulator 132 in between. The insulator 132 covers the surfaces of the teeth 131B around which the coils 133 are wound. The insulator 132 does not cover the outer surfaces of the teeth 131B facing radially outward. The stator core 131 and the coils 133 are insulated from each other by the insulator 132.

The stator base 140 supports the stator core 131. The stator base 140 is fixed to the stator core 131. The stator base 140 is formed from aluminum. The stator base 140 includes a plate 141, a peripheral wall 142, and a pipe 143.

The plate 141 is substantially annular. The plate 141 surrounds the rotation axis AX. The plate 141 is located above the stator 130.

The peripheral wall 142 is substantially cylindrical. The peripheral wall 142 has an upper end connected to the periphery of the plate 141. The plate 141 and the peripheral wall 142 are integral with each other. The peripheral wall 142 extends downward from the periphery of the plate 141. The peripheral wall 142 surrounds the yoke 111B in the rotor cup 111.

The pipe 143 is substantially cylindrical. The pipe 143 protrudes downward from a center portion of the lower surface of the plate 141. The pipe 143 surrounds the rotation axis AX. The pipe 143 has its central axis aligned with the rotation axis AX.

The pipe 143 is located at least partially inside the stator core 131. The pipe 143 has the central axis aligned with the central axis of the yoke 131A.

The pipe 143 in the embodiment includes a smaller-diameter portion 143A and a larger-diameter portion 143B. The larger-diameter portion 143B is located upward from the smaller-diameter portion 143A. The smaller-diameter portion 143A and the larger-diameter portion 143B are both cylindrical. The larger-diameter portion 143B has a larger outer diameter than the smaller-diameter portion 143A. The stator core 131 surrounds the smaller-diameter portion 143A. The smaller-diameter portion 143A is located inward from the stator core 131. The larger-diameter portion 143B is located outward from the stator core 131. The larger-diameter portion 143B is located above the stator core 131. The stator core 131 is fixed to the pipe 143. The stator base 140 is fixed to the stator 130 with the central axis of the pipe 143 aligned with the central axis of the yoke 131A.

The motor 104 includes a motor positioner 170. The motor positioner 170 positions the stator base 140 relative to the stator core 131.

The smaller-diameter portion 143A of the pipe 143 in the embodiment has an outer surface including base flat areas 171. The base flat areas 171 are located circumferentially at least two positions. In the embodiment, one base flat area 171 is located frontward from the rotation axis AX, and the other base flat area 171 is located rearward from the rotation axis AX. The two base flat areas 171 are substantially parallel to each other. The smaller-diameter portion 143A of the pipe 143 has the outer surface including base curved areas 172. One base curved area 172 is located leftward from the rotation axis AX, and the other base curved area 172 is located rightward from the rotation axis AX.

The yoke 131A in the stator core 131 has an inner surface including stator flat areas 173 and stator curved areas 174. The stator flat areas 173 are in contact with the base flat areas 171. The stator curved areas 174 are in contact with the base curved areas 172.

The motor positioner 170 includes the base flat areas 171 and the stator flat areas 173 in contact with the base flat areas 171. The motor positioner 170 includes the base curved areas 172 and the stator curved areas 174 in contact with the base curved areas 172.

The base flat areas 171 in contact with the stator flat areas 173 allow the stator base 140 to be positioned relative to the stator core 131 both circumferentially and radially. The base curved areas 172 in contact with the stator curved areas 174 allow the stator base 140 to be positioned relative to the stator core 131 both circumferentially and radially.

The pipe 143 has a base support surface 143C including the boundary between the smaller-diameter portion 143A and the larger-diameter portion 143B. The base support surface 143C faces downward. The base support surface 143C surrounds the smaller-diameter portion 143A.

The base support surface 143C is in contact with the upper end face of the stator core 131. The base support surface 143C is in contact with the upper end face of the yoke 131A in the stator core 131.

The motor positioner 170 has the base support surface 143C. The base support surface 143C in contact with the upper end face of the yoke 131A allows the stator base 140 to be positioned relative to the stator core 131 in the axial direction.

The stator core 131 and the stator base 140 in the embodiment are fastened together with screws 175. The yoke 131A has core threaded openings 131C. Each core threaded opening 131C is a through-hole extending from the upper end face to the lower end face of the yoke 131A. Multiple core threaded openings 131C surround the rotation axis AX at intervals. Screw bosses 144 surround the pipe 143. The screw bosses 144 surround the larger-diameter portion 143B. Each screw boss 144 has a base threaded hole 144A. Multiple screw bosses 144 surround the larger-diameter portion 143B at intervals. In other words, multiple base threaded holes 144A surround the rotation axis AX at intervals.

At least six core threaded openings 131C and at least six base threaded hole 144A are located. In the embodiment, six core threaded openings 131C and six base threaded holes 144A surround the rotation axis AX at equal intervals.

The stator core 131 and the stator base 140 are fastened together with six screws 175. The screws 175 are placed into the corresponding core threaded openings 131C from below the stator core 131. Each screw 175 placed through the corresponding core threaded opening 131C has the distal end to be received in the corresponding base threaded hole 144A in the screw boss 144. Threads on the screws 175 are engaged with threaded grooves on the base threaded holes 144A to fasten the stator core 131 and the stator base 140 together.

The motor positioner 170 includes the screws 175 each placed into the corresponding base threaded hole 144A through the corresponding core threaded opening 131C. The stator base 140 and the stator core 131 are fastened together with the screws 175.

The pipe 143 supports the rotor shaft 120 with a bearing 121 in between. The bearing 121 is received in the pipe 143. The rotor shaft 120 includes an upper portion located in the pipe 143. The bearing 121 supports the upper portion of the rotor shaft 120 in a rotatable manner. The rotor shaft 120 is supported by the pipe 143 with the bearing 121 in between.

The stator base 140 includes an annular plate 145 located on the upper end of the pipe 143. The bearing 121 has its upper surface located below the lower surface of the annular plate 145. A wave washer 122 is located between the upper surface of the bearing 121 and the lower surface of the annular plate 145. The bearing 121 has an outer circumferential surface supported on the inner surface of the pipe 143. The bearing 121 has the upper surface supported by the annular plate 145 with the wave washer 122 in between.

The sensor board 150 is supported by the stator base 140. The sensor board 150 is in contact with the stator base 140. The sensor board 150 is fixed to the stator base 140. The sensor board 150 includes magnetic sensors 153 for detecting the magnets 113 in the rotor 110. The magnetic sensors 153 detect the magnetic flux of the magnets 113. The magnetic sensors 153 detect changes of the magnetic flux resulting from rotation of the rotor 110 to detect the position of the rotor 110 in the rotation direction. The sensor board 150 is supported by the stator base 140 with the magnetic sensors 153 facing the magnets 113. The sensor board 150 is radially outward from the coils 133.

The motor housing 160 accommodates the rotor 110 and the stator 130. The motor housing 160 is connected to the stator base 140. An internal space between the motor housing 160 and the stator base 140 accommodates the rotor 110 and the stator 130.

The motor housing 160 includes a plate 161, a peripheral wall 162, and a flange 163.

The plate 161 is substantially annular. The plate 161 is located below the rotor cup 111. The plate 161 includes a pipe 164 at its center. A lower portion of the rotor shaft 120 is located in the pipe 164.

The motor housing 160 supports a bearing 123. The bearing 123 supports the lower portion of the rotor shaft 120 in a rotatable manner. The motor housing 160 includes an annular plate 165 located at the lower end of the pipe 164. The bearing 123 has a lower surface located above the upper surface of the annular plate 165. The bearing 123 has an outer circumferential surface supported on the inner surface of the pipe 164. The bearing 123 has the lower surface supported on the upper surface of the annular plate 165.

The peripheral wall 162 is substantially cylindrical. The peripheral wall 162 has its lower end connected to the periphery of the plate 161. The peripheral wall 162 protrudes upward from the periphery of the plate 161. The peripheral wall 162 at least partially surrounds the rotor cup 111.

The flange 163 is connected to the upper end of the peripheral wall 162. The flange 163 extends radially outward from the upper end of the peripheral wall 162. The flange 163 has multiple (four in the present embodiment) through-holes 166 located circumferentially at intervals. The peripheral wall 142 of the stator base 140 includes multiple (four in the present embodiment) screw bosses 146 located circumferentially at intervals. Each screw boss 146 has a threaded hole. The stator base 140 and the motor housing 160 are fastened together with four screws 167. The screws 167 are placed into the corresponding through-holes 166 from below the flange 163. Each screw 167 placed through the corresponding through-hole 166 has the distal end to be received in the corresponding threaded hole in the screw boss 146. Threads on the screws 167 are engaged with threaded grooves on the threaded holes in the screw bosses 146 to fasten the stator base 140 and the motor housing 160 together.

The peripheral wall 142 of the stator base 140 has multiple openings 147. One of the openings 147 receives a shock absorber 148. The shock absorber 148 is formed from, for example, rubber. The shock absorber 148 received in the opening 147 supports at least a part of a power line 191 (described later). The shock absorber 148 reduces wear of the power line 191.

The plate 161 has an air passage 168. The air passage 168 includes a flow channel with a labyrinth structure. For the rotor shaft 120 receiving a cooling fan fixed to its lower end, the cooling fan rotates as the rotor shaft 120 rotates. The cooling fan draws air through the air passage 168 from the internal space between the stator base 140 and the motor housing 160. Air around the motor 104 flows into the internal space through the openings 147. This cools the motor 104.

The rotor cup 111 has outlets 115. The outlets 115 discharge foreign matter inside the rotor cup 111. Two outlets 115 are located in the plate 111A. For example, water entering the rotor cup 111 is discharged out of the rotor cup 111 through the outlets 115.

As shown in FIG. 19, the motor housing 160 includes screw bosses 600. The screw bosses 600 are fastened to decks 200 on the housing 102. Each deck 200 has a through-hole 201. Each screw boss 600 has a threaded hole 601. The decks 200 on the housing 102 and the motor housing 160 are fastened together with screws 202. Each screw 202 is placed into the corresponding through-hole 201 from below the corresponding deck 200. Each screw 202 placed through the corresponding through-hole 201 has the distal end to be received in the corresponding threaded hole 601 in the screw boss 600. Threads on the screws 202 are engaged with threaded grooves on the threaded holes 601 to fasten the decks 200 on the housing 102 and the motor housing 160 together.

The motor housing 160 includes screw bosses 602 fastened to a baffle 203. The baffle 203 changes airflow inside the motor housing 160. The baffle 203 faces the lower surface of the motor housing 160. The baffle 203 has an opening 203A at its center. The rotor shaft 120 is placed in the opening 203A. The baffle 203 has through-holes 204. Each screw boss 602 has a threaded hole 603. The baffle 203 and the motor housing 160 are fastened together with screws 205. The screws 205 are placed into the corresponding through-holes 204 from below the baffle 203. Each screw 205 placed through the corresponding through-hole 204 has the distal end to be received in the corresponding threaded hole 603 in the screw boss 602. Threads on the screws 205 are engaged with threaded grooves on the threaded holes 603 to fasten the baffle 203 and the motor housing 160 together.

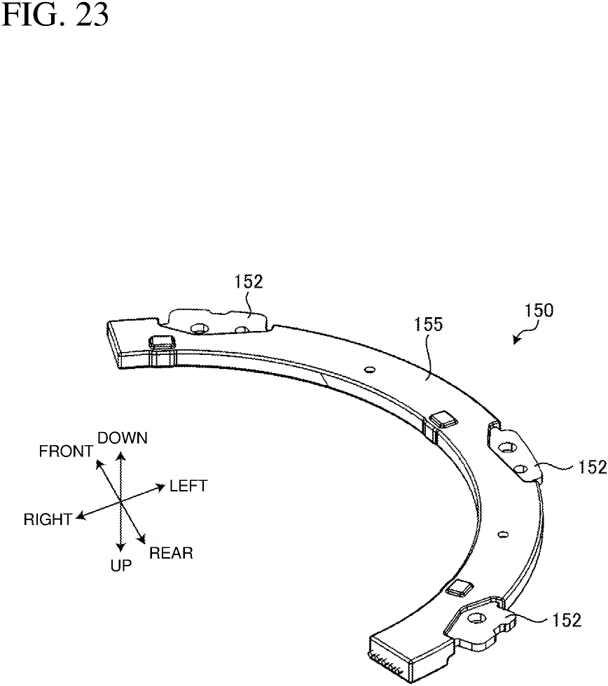

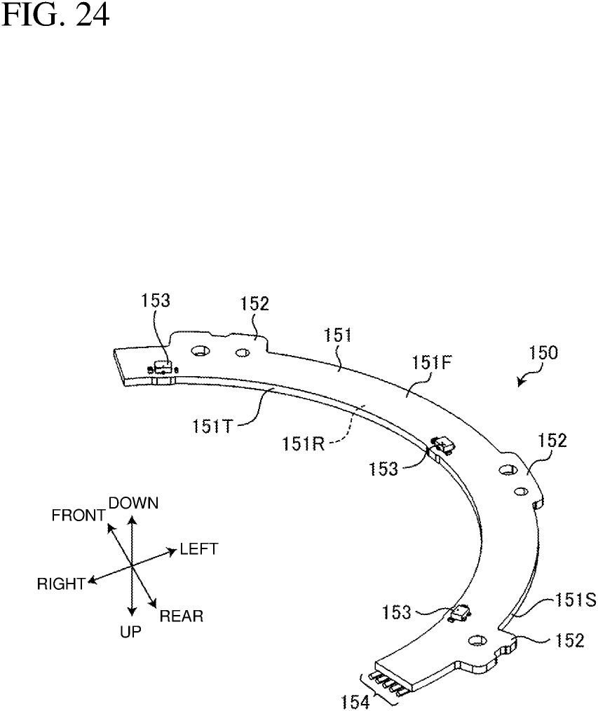

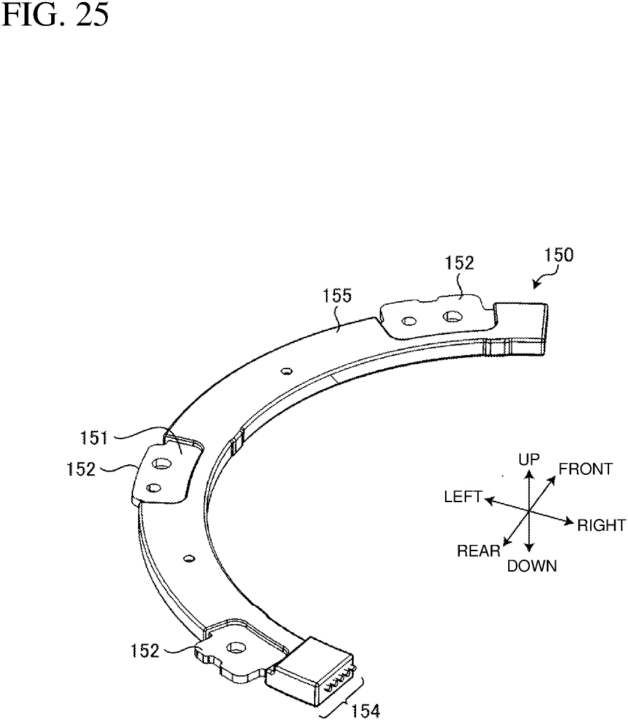

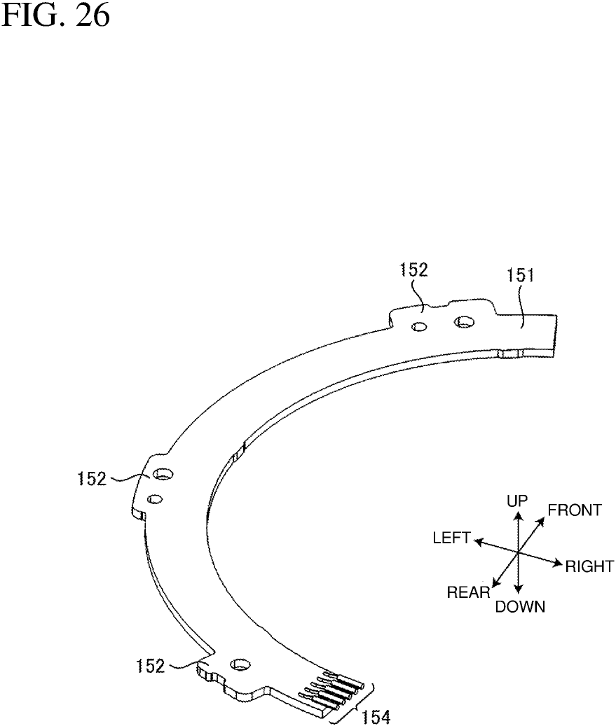

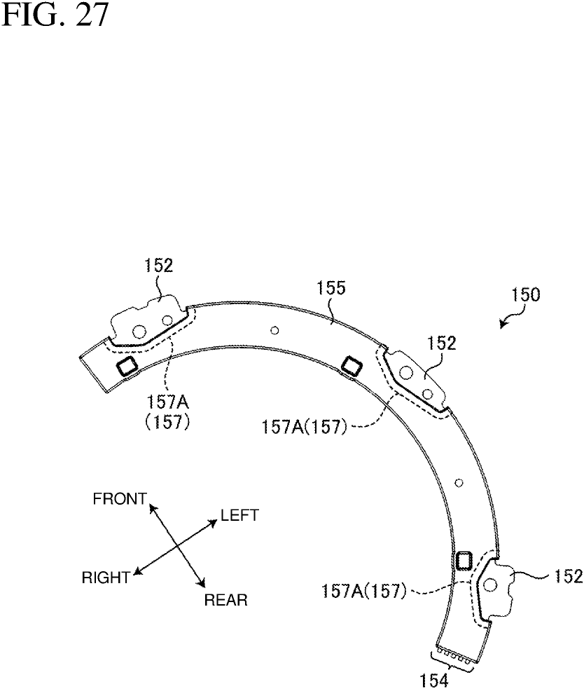

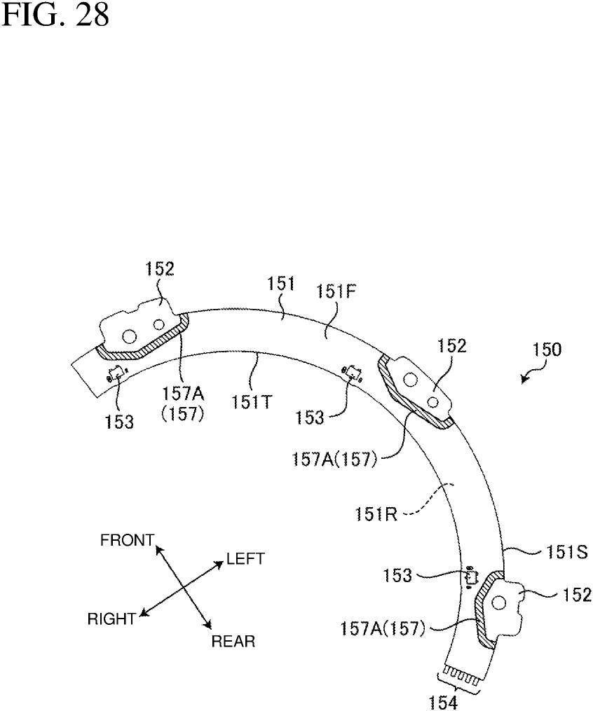

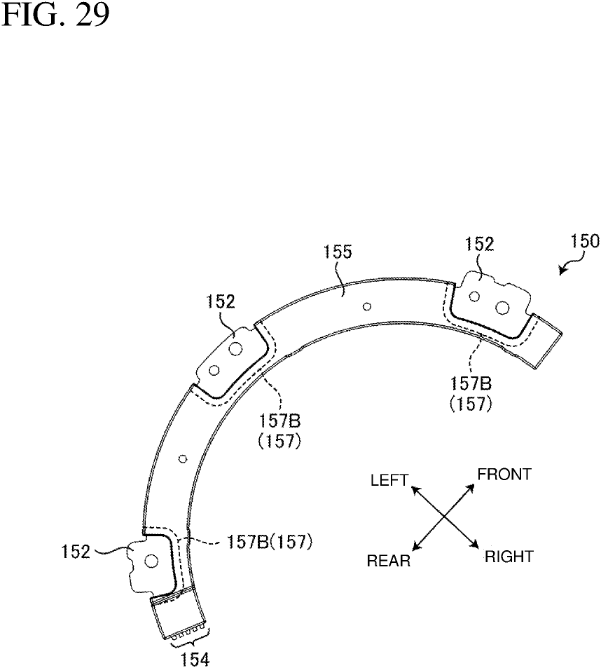

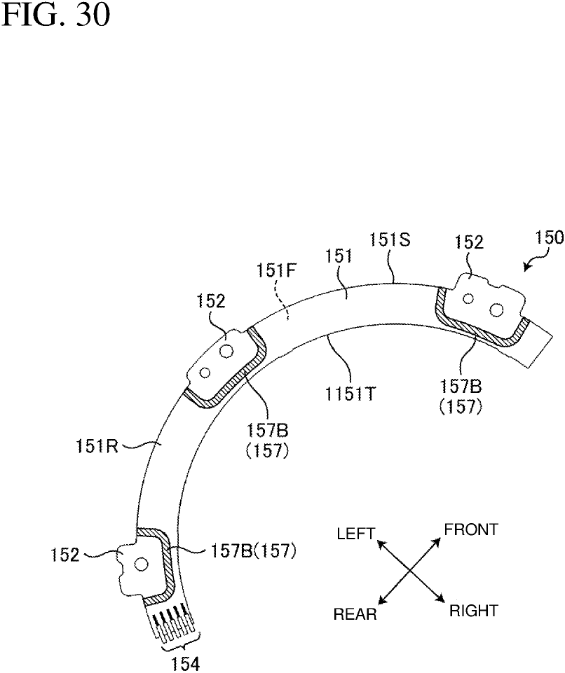

FIG. 23 is a perspective view of the sensor board in the second embodiment as viewed from below. FIG. 24 is a partial perspective view of the sensor board in the second embodiment as viewed from below. FIG. 25 is a perspective view of the sensor board in the second embodiment as viewed from above. FIG. 26 is a partial perspective view of the sensor board in the second embodiment as viewed from above. FIG. 27 is a plan view of the sensor board in the second embodiment as viewed from below. FIG. 28 is a partial plan view of the sensor board in the second embodiment as viewed from below. FIG. 29 is a plan view of the sensor board in the second embodiment as viewed from above. FIG. 30 is a partial plan view of the sensor board in the second embodiment as viewed from above.

As shown in FIGS. 23 to 30, the sensor board 150 includes a circuit board 151, exposed portions 152, multiple (three in the present embodiment) magnetic sensors 153, and signal lines 154.

The sensor board 150 is substantially arc-shaped. The circuit board (substrate) 151 includes a printed circuit board (PCB). The circuit board 151 has an opposing surface 151F opposing the rotor core 112 and side surfaces 151S and 151T adjacent to the opposing surface 151F. The side surface 1515 is a radially outer surface, or more specifically, an outer peripheral surface. The side surface 151T is a radially inner surface, or more specifically, an inner peripheral surface.

The exposed portions 152 partially protrude radially outward from the peripheral edge of the circuit board 151. Three exposed portions 152 are located on the side surface 151S at intervals of 60°.

The magnetic sensors 153 are located on the opposing surface 151F. The magnetic sensors 153 face the rotor core 112. In this state, the magnetic sensors 153 detect rotation of the rotor 110. The magnetic sensors 153 each include a Hall device. The detection signals from the magnetic sensors 153 are output through the signal lines 154.

The electric work machine 101 includes a resin-molded portion 155 covering the opposing surface 151F of the circuit board 151. The resin-molded portion 155 includes sensor covers 155B covering the magnetic sensors 153. The sensor covers 155B each have a height from the opposing surface 151F greater than other portions. The opposing surface 151F of the circuit board 151 receives, for example, electronic components and wiring in addition to the magnetic sensors 153. The resin-molded portion 155 also covers these electronic components and wiring. Examples of the electronic components include capacitors, resistors, and thermistors.

The resin-molded portion 155 extends across the opposing surface 151F and the side surfaces 151S and 151T of the circuit board 151. The resin-molded portion 155 extends across a rear surface 151R and the side surfaces 151S and 151T of the circuit board 151. The resin-molded portion 155 is not located on the surfaces of the exposed portions 152. The resin-molded portion 155 extends across the opposing surface 151F, the rear surface 151R, and the side surfaces 151S and 151T of the circuit board 151, thus increasing the bonding strength between the resin-molded portion 155 and the circuit board 151.

The opposing surface 151F and the rear surface 151R of the circuit board 151 receive, for example, the wiring connected to electronic components such as the magnetic sensors 153. The opposing surface 151F and the rear surface 151R include a resist layer covering an area with the wiring. The opposing surface 151F and the rear surface 151R include resist-free areas 157 without the resist layer.

In the resist-free areas 157, the opposing surface 151F or the rear surface 151R of the circuit board 151 is exposed. The resist-free areas 157 include first areas 157A on the opposing surface 151F and second areas 157B on the rear surface 151R. The first areas 157A and the second areas 157B include the boundaries between the circuit board 151 and the exposed portions 152 and the periphery of the resin-molded portion 155. In the resist-free areas 157, the opposing surface 151F and the rear surface 151R are exposed, and thus the resin-molded portion 155 is in direct contact with the opposing surface 151F and the rear surface 151R. The resin-molded portion 155 has a higher bonding strength in the resist-free areas 157 than in the area with the resist layer.

The resin-molded portion 155 in the present embodiment extends across the opposing surface 151F and the side surfaces 151S and 151T of the sensor board 150 and the rear surface 151R opposite to the opposing surface 151F.

The resin-molded portion 155 thus protects the entire sensor board 150 more reliably.

Although the motor 104 is an outer-rotor brushless motor in the second embodiment, the motor 104 may have another structure. The motor 104 is an inner-rotor brushless motor.

The electric work machines 1 and 101 according to the above embodiments are outdoor power equipment (a chain saw and a lawn mower). The outdoor power equipment may not be a chain saw and a lawn mower. Examples of the outdoor power equipment include a hedge trimmer, a mowing machine, and a blower. The electric work machine 101 may be a power tool. Examples of the power tool include a driver drill, a vibration driver drill, an angle drill, an impact driver, a grinder, a hammer, a hammer drill, a circular saw, and a reciprocating saw.

In the above embodiments, the electric work machine is powered by the battery pack attached to the battery mount. In some embodiments, the electric work machine may use utility power (alternating current power supply).

Reference Signs List

| AX | rotation axis |
|---|---|
| 1, 101 | electric work machine |
| 2, 102 | housing |
| 2A | motor compartment |
| 2B | battery holder |
| 2C | rear grip |
| 3 | front grip |
| 4 | hand guard |
| 5, 108 | battery mount |
| 6, 104 | motor |
| 7 | trigger switch |
| 8 | trigger lock lever |
| 9 | guide bar |
| 10 | saw chain |
| 11 | controller |
| 12, 109 | battery pack |
| 17 | fan |
| 19 | through-hole |
| 20, 130 | stator |
| 21 | stator core |
| 21T, 131B | tooth |
| 22 | front insulator |
| 22T, 23T | protrusion |
| 23 | rear insulator |
| 24, 133 | coil |
| 25, 191 | power line |
| 26 | fusing terminal |
| 27 | short-circuiting member |
| 27A, 111C, 147, 203A | opening |
| 28 | insulating member |
| 28A | body |
| 28B, 42 | screw boss |
| 28C | support |
| 29 | connection wire |
| 30, 110 | rotor |
| 31, 112 | rotor core |
| 31F | front end |
| 31R | rear end |
| 31S | outer surface |
| 32, 120 | rotor shaft |
| 33 | permanent magnet |
| 34 | magnetic pole unit |
| 34N | first magnetic pole unit |
| 34S | second magnetic pole unit |
| 37 | shaft opening |
| 40, 150 | sensor board |
| 41, 111A, 141, 161 | plate |
| 41, 41S, 41T, 151S, 151T | side surface |
| 41A | recess-protrusion portion |
| 41B, 41C, 45A | recess |
| 41F, 151F | opposing surface |
| 43, 153 | magnetic sensor |
| 44, 154 | signal line |
| 44A | signal line holder |
| 45, 155 | resin-molded portion |
| 45B, 155B | sensor cover |
| 46 | projection |
| 47, 157 | resist-free area |
| 47A, 157A | first area |
| 47B, 157B | second area |
| 47C | third area |
| 48 | resist layer |
| 50 | magnet slot |
| 71 | space |
| 73 | resin portion |
| 103 | wheel |
| 105 | cutting blade |
| 106 | grass box |
| 107 | handle |
| 111 | rotor cup |
| 111B | yoke |
| 113 | magnet |
| 114 | bush |
| 115 | outlet |
| 121, 123 | bearing |
| 122 | wave washer |
| 131 | stator core |
| 131A | yoke |
| 131C | core threaded opening |
| 132 | insulator |
| 140 | stator base |
| 142, 162 | peripheral wall |
| 143, 164 | pipe |
| 143A | smaller-diameter portion |
| 143B | larger-diameter portion |
| 143C | base support surface |
| 144, 146, 600, 602 | screw boss |
| 144A | base threaded hole |
| 145, 165 | annular plate |
| 148 | shock absorber |
| 151 | circuit board |
| 151R | rear surface |
| 152 | exposed portion |
| 160 | motor housing |
| 163 | flange |
| 166, 201, 204 | through-hole |
| 167, 175, 202, 205 | screw |
| 168 | air passage |
| 170 | motor positioner |
| 171 | base flat area |
| 172 | base curved area |
| 173 | stator flat area |
| 174 | stator curved area |
| 200 | deck |
| 203 | baffle |
| 601, 603 | threaded hole |

What is claimed is:

1. An electric work machine, comprising:
a brushless motor including a stator and a rotor rotatable relative to the stator;
a sensor board facing the rotor and the stator in an axial direction along a rotation axis of the rotor, the sensor board including a sensor on an opposing surface of the sensor board, the opposing surface opposing the rotor and the stator, the sensor being configured to detect a position of the rotor in a rotation direction;
a resin-molded portion covering the opposing surface of the sensor board and having a recess at a position corresponding to the stator; and
an output unit directly or indirectly drivable by the rotor.

2. The electric work machine according to claim 1, wherein
the rotor includes a rotor core and a permanent magnet fixed to the rotor core,
the stator includes a stator core, an insulator fixed to the stator core, and a coil attached to the insulator, and
the recess is at a position corresponding to the coil.

3. The electric work machine according to claim 2, wherein
the recess overlaps the coil as viewed in the axial direction.

4. An electric work machine, comprising:
a brushless motor including a stator and a rotor rotatable relative to the stator;
a sensor board facing the rotor in an axial direction along a rotation axis of the rotor, the sensor board including
a sensor on an opposing surface of the sensor board, the opposing surface opposing the rotor, the sensor being configured to detect a position of the rotor in a rotation direction, and
a recess-protrusion portion in a portion of a side surface adjacent to the opposing surface;
a resin-molded portion covering the opposing surface of the sensor board and extending to a position on the opposing surface corresponding to the recess-protrusion portion; and
an output unit directly or indirectly drivable by the rotor.

5. The electric work machine according to claim 4, wherein
the resin-molded portion extends across the opposing surface and the side surface.

6. The electric work machine according to claim 4, wherein
the sensor board is annular, and
the side surface includes an outer side surface and an inner side surface of the sensor board.

7. An electric work machine, comprising:
a brushless motor including a stator and a rotor rotatable relative to the stator;
a sensor board facing the rotor in an axial direction along a rotation axis of the rotor, the sensor board including
a sensor on an opposing surface of the sensor board, the opposing surface opposing the rotor, the sensor being configured to detect a position of the rotor in a rotation direction,
a substrate having the opposing surface receiving the sensor and wiring connected to the sensor, and
a resist layer covering an area with the wiring on the opposing surface;
a resin-molded portion covering the opposing surface of the sensor board; and
an output unit directly or indirectly drivable by the rotor,
wherein the substrate includes a resist-free area without the resist layer in at least a portion of the opposing surface, and
the resin-molded portion is in direct contact with the opposing surface in the resist-free area.

8. The electric work machine according to claim 7, wherein
the resist-free area includes a peripheral portion of the opposing surface.

9. The electric work machine according to claim 8, wherein
the sensor board is annular, and
the peripheral portion includes an outer peripheral portion and an inner peripheral portion of the sensor board.

10. The electric work machine according to claim 4, wherein
the resin-molded portion extends across the opposing surface and the side surface of the sensor board and a surface of the sensor board opposite to the opposing surface.

11. The electric work machine according to claim 5, wherein
the sensor board is annular, and
the side surface includes an outer side surface and an inner side surface of the sensor board.

12. The electric work machine according to claim 5, wherein
the resin-molded portion extends across the opposing surface and the side surface of the sensor board and a surface of the sensor board opposite to the opposing surface.

13. The electric work machine according to claim 6, wherein
the resin-molded portion extends across the opposing surface and the side surface of the sensor board and a surface of the sensor board opposite to the opposing surface.

14. The electric work machine according to claim 7, wherein
the resin-molded portion extends across the opposing surface and the side surface of the sensor board and a surface of the sensor board opposite to the opposing surface.

15. The electric work machine according to claim 8, wherein
the resin-molded portion extends across the opposing surface and the side surface of the sensor board and a surface of the sensor board opposite to the opposing surface.

16. The electric work machine according to claim 9, wherein
the resin-molded portion extends across the opposing surface and the side surface of the sensor board and a surface of the sensor board opposite to the opposing surface.
